(19) United States
(12) Patent Application Publication
(10) Pub. No.: US 2015/0269348 A1
(43) Pub. Date: Sep. 24, 2015

(54) SYSTEMS AND METHODS FOR HEALTH MANAGEMENT

(71) Applicant: AsthmaMD, Inc., San Francisco, CA (US)

(72) Inventors: Salim Madjd, San Mateo, CA (US); Sam Pejham, Danville, CA (US)

(21) Appl. No.: 14/667,200

(22) Filed: Mar. 24, 2015

Related U.S. Application Data
(60) Provisional application No. 61/969,799, filed on Mar. 24, 2014.

(51) Int. Cl. G06F 19/00

(52) U.S. Cl. CPC G06F 19/3431; G06F 19/328; G06F 19/3456; G06F 19/322

(57) ABSTRACT

The present disclosure provides systems and methods for health management. The system can be configured to monitor status and treatment of a health condition of a user. The systems and methods can facilitate creation and adherence to action plans, and medication fulfillment.

### CROSS REFERENCE

This application claims the benefit of U.S. Provisional Patent Application No. 61/969,799, filed on Mar. 24, 2014, which is incorporated by reference in its entirety.

### BACKGROUND OF THE INVENTION

Many health conditions and chronic disorders require careful management of symptoms and medication usage. Adherence to physician-recommended action plans can be challenging for patients on a routine basis. Systems and methods that monitor treatment, medication, and health status of users can facilitate health management.

### SUMMARY OF THE INVENTION

In some embodiments, the invention provides a method of managing a health condition of a subject, the method comprising: a) collecting data related to the health condition of the subject, wherein the data comprise a result of a breathing test of the subject; b) comparing the data obtained from the subject with normal data for the health condition, wherein the normal data represents a status of the subject's health condition when in a state of good health; c) determining by a processor of a computer system a level of severity of the health condition based on the comparing; and d) providing an action plan for the subject based on the level of severity of the health condition, wherein the action plan comprises individualized instructions to manage the health condition.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

FIG. 1 schematically illustrates a system for implementing methods of the disclosure.

FIG. 2 schematically illustrates a server-based health management system.

FIGS. 3A-3D show screenshots of a graphical user interface showing a list of medications.

FIGS. 4A-4C show screenshots of graphical user interfaces of a health management system in which a user can select specific medications, doses, and frequency for individual action plan zones.

FIG. 4D shows screenshots of graphical user interfaces of a health management system in which a user can enter information and set up reminders.

FIG. 5A shows screenshots of a user interface with instructions associated with an action plan zone and a user interface for measurements and symptoms.

FIG. 5B shows screenshots of a user interface associated with implementation of an action plan zone and an interface where a user can input administered medications.

FIG. 5C is an example of an action plan.

FIG. 5D shows illustrative screenshots of action plans generated using the systems and methods of the disclosure.

FIG. 6 is an example of display functionality on a user display device.

FIG. 7 schematically illustrates a method for updating a health management system.

FIG. 8A schematically illustrates a method for creating an action plan.

FIG. 8B schematically illustrates an example of a method for interacting with a health management system to create an action plan.

FIG. 9 is an example of a method for identifying medication.

FIG. 10 shows a system comprising a computer system.

FIG. 11A schematically illustrates a method for specifying zones.

FIG. 11B schematically illustrates a method for specifying prescription and insurance information.

FIG. 11C schematically illustrates a method for specifying medication pricing.

FIG. 12 schematically illustrates a method for ordering medication.

FIG. 13 is an example of a health management system interacting with various entities.

FIG. 14 is an example of features and services provided to a user of a health management system.

FIG. 15 schematically illustrates benefits of systems and methods for health management in accordance with the present disclosure.

FIG. 16 schematically illustrates revenue streams associated with health management services in accordance with the present disclosure.

FIGS. 17-19 schematically illustrate methods for interacting with a user via an interactive action plan.

FIG. 20 is a block diagram illustrating a first example architecture of a computer system that can be used in connection with example embodiments of the present invention.

FIG. 21 is a diagram illustrating a computer network that can be used in connection with example embodiments of the present invention.

FIG. 22 is a block diagram illustrating a second example architecture of a computer system that can be used in connection with example embodiments of the present invention.

FIG. 23 illustrates a global network that can transmit a product of the invention.

### DETAILED DESCRIPTION

The present disclosure provides systems and methods for health management. Health management can include, for example, monitoring of one or more health conditions, medication usage, medical history, life events, activities, or any combination thereof. Health management can include, for example, providing a treatment or action plan. In some cases, the health management systems of the disclosure can be applied to management of asthma. Any aspect of the disclosure described in relation to asthma can equally apply to other health conditions, or lack thereof, at least in some configurations.

The systems and methods described herein can be applied to any health condition. Non-limiting examples of health conditions include asthma, allergy, diabetes, arthritis, cardiovascular disease, hypertension, addiction management, hepatitis, chronic kidney disease, chronic pain management, lupus, multiple sclerosis, sleep apnea, Alzheimer's disease, Parkinson's Disease, ulcerative colitis, Crohn's disease, Celiac's disease, cancer, coronary artery disease, cerebral palsy, endometriosis, fibromyalgia, epilepsy, schizophrenia, osteoporosis, sickle cell anemia, Lyme disease, dementia, congestive heart failure, alcoholism, drug addiction, obesity, depression, hyperthyroidism, hypothyroidism, atrial fibrillation, HIV, attention deficit hyperactivity disorder, tuberculosis, malaria, myocardial infarction, multiple sclerosis, and chronic obstructive pulmonary disease (COPD). In some embodiments, the health condition is asthma. In some embodiments, the health condition is a chronic health condition or disorder. In some embodiments, the health condition is chronic obstructive pulmonary disease (COPD).

An aspect of the disclosure is directed to a system for managing a health condition of a user, comprising a communications interface operatively coupled to a user terminal and a healthcare provider terminal. The communications interface can be adapted to collect information from the user terminal, the healthcare provider terminal, or a combination thereof. The information collected can comprise, for example, information related to the health condition of the user, information about a medication administered to the user, and information about a physical condition of the user. The system can further comprise a data storage medium operatively coupled to the communications interface, and adapted to store the user information. The data storage medium can be coupled to a computer processor and programmed to create an individualized action plan based on the user information stored in the data storage medium. The action plan can comprise one or more individualized instructions that can facilitate the user to manage the health condition of the user.

The individualized instructions provided by the system can comprise directions to administer a medication. At least a portion of the action plan can be reviewed by a healthcare provider. Further, at least a portion of the action plan can be approved by the healthcare provider. The communications interface can further be operatively coupled to an entity terminal. In some cases, information collected from the communications interface or from the entity terminal comprises medication fulfillment information. In some cases, information collected from the communications interface or from the entity terminal comprises health insurance information. The user terminal or the healthcare provider terminal can be a mobile device. The mobile device can be a smartphone. The user terminal or the healthcare provider terminal can be a computer. The user terminal can be operatively coupled to a display. In some cases, the action plan is displayed on the display. In some cases, the display further comprises a graphical user interface. The system can further comprise a user application. The user application can be programmed to be implemented upon execution by the computer processor. The user application can be programmed to be implemented upon execution by another computer processor residing on the user terminal. The user application can be downloaded to the user device. The system can further comprise a service. The service can be selected from, for example, medication services, action plan services, and core services.

The systems and methods of the disclosure can include an application capable of performing health management-related functions and calculations using inputs from, for example, a user, a communications network, a component, a device, or any combination thereof. System inputs can include, for example, prescription information from a healthcare provider, which can include prescription renewal, prescription history from a database, prescription information transmitted over a network, reimbursement information, medication pricing information, medical history, healthcare provider feedback, and user preferences. System outputs can include, for example, action items and recommendations to the user, for example, health status, health data, health management plan provided to the user on a display device of the user; prescription and prescription-related information generated by the system; automatic and user-generated emergency information; signals transmitted to a healthcare provider; signals transmitted to an emergency health provider; medication purchases or orders; renewal of medications; a control signal to a hardware component; a control signal to a peripheral device; and other reporting functions.

Non-limiting examples of users of the system include patients, healthcare providers, social workers, hospitals, hospital administrators, hospital contractors, health workers, clinicians, attendants, insurance companies, governmental bodies, government agency, researchers, nursing home, school, community health organization, military institution, and correctional institution. A user can be, for example, an elderly adult, adult, adolescent, child, a toddler, or an infant.

Non-limiting examples of healthcare providers include physicians, dentists, pharmacists, physician assistants, nurses, surgeons, surgeon's assistant, surgical technologist, midwives, dietitians, therapists, psychologists, chiropractors, clinical officers, social workers, phlebotomists, physical therapists, respiratory therapists, occupational therapists, audiologists, speech pathologists, optometrists, emergency medical technicians, paramedics, medical laboratory scientists, medical prosthetic technicians, physician's assistant, therapist, clinician, and radiographers.

A user can be a subject. A subject can be, for example, an elderly adult, an adult, an adolescent, a child, a toddler, or an infant. A subject can be a patient.

The application can allow users to log easily and quickly, for example, asthma activity, medications, causes of asthma, and other information in the form of a diary. In some cases, users can share, for example, the diary and a color graph chart of the asthma activities with healthcare providers to be included in the user's medical records.

The systems and methods of the disclosure can be used to collect health data, for example, anonymous asthma data, from a large group of users to determine statistical information regarding causes and external correlation of a health condition. In some cases, user data collection can be provided as an opt-in feature that allows the application to securely send encrypted and anonymous data, for example, severity of asthma attacks, triggers, time, date, location, and weather conditions. The information can be stored in a memory location, for example, a database.

The application can be installed, updated, and maintained as a computer program or application. The application can be downloaded to a computing device, for example, a smartphone, tablet, a hardware component, or a peripheral device of the user. The application can be implemented remotely, for example, on an external or remote cloud server in communication with a display device of the user. The application can be programmed to be implemented, with the aid of a computer processor, within an operating system embedded on, for example, a user device or terminal such as a computing device, or on external servers. Operation of the health management systems can be based on adaptive rules and algorithms.

The systems and methods of the disclosure can further be combined with, for example, one or more hardware components and peripheral devices. In some cases, the components and devices can be provided as separate devices. For example, a peak flow meter can be used in conjunction with a health management system, such as an asthma management system. In some cases, the components and devices can be in communication with the health management system. For example, the components and devices can be programmed to facilitate communication with the health management system upon execution by a computer processor. Further, in some cases, the components and devices can be integrated into the health management system. In some cases, the health management system can be configured for use with a given type or model of hardware component or peripheral device.

In some implementations, health management can include a management plan, such as an action plan. For example, asthma management can include an asthma action plan. In another example, chronic obstructive pulmonary disease (COPD) management can include a chronic obstructive pulmonary disease (COPD) action plan. The action plan can be a plan developed by a user, such as patient, or a healthcare provider, to help control the patient's health condition. The action plan can be a written, individualized worksheet that shows the steps to take to lessen a likelihood that the health condition worsens. In some cases, the action plan can include information about daily treatment, for example, what kind of medications to take and when to take them, how to control asthma long-term, how to handle worsening asthma or attacks, and when to call the healthcare provider or go to the emergency room. The action plan can include, for example, personal information, such as name and emergency contact information, contact information for healthcare provider, such as emergency telephone numbers for the healthcare provider, emergency department, and rapid transportation to emergency room, severity classification, and a list of triggers that can make the health condition worse.

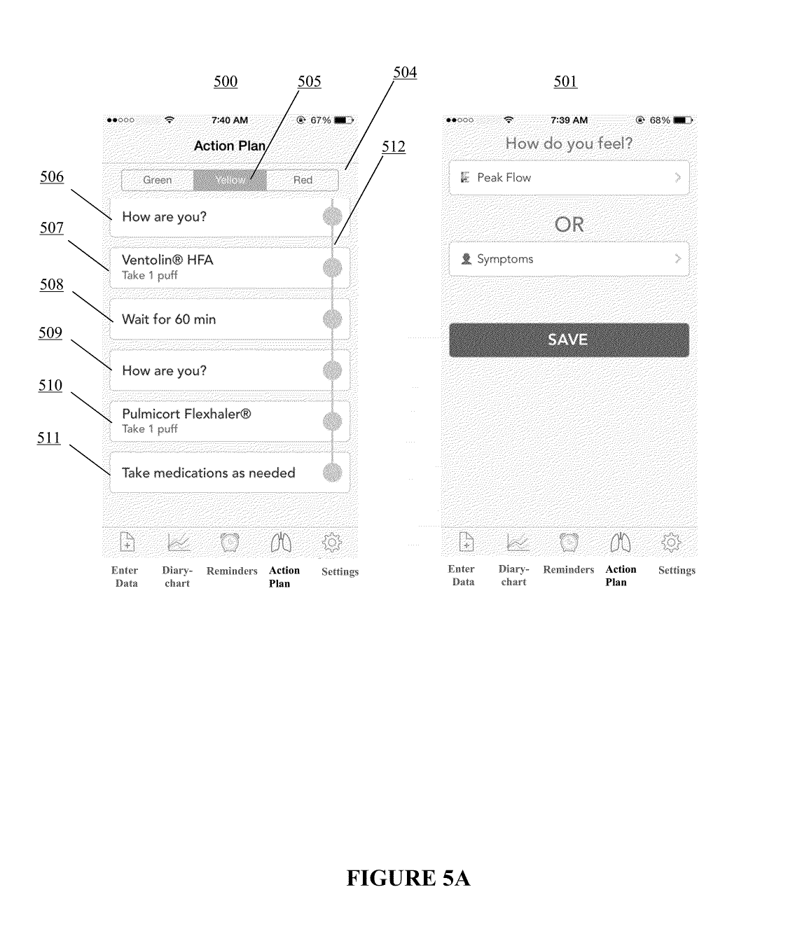

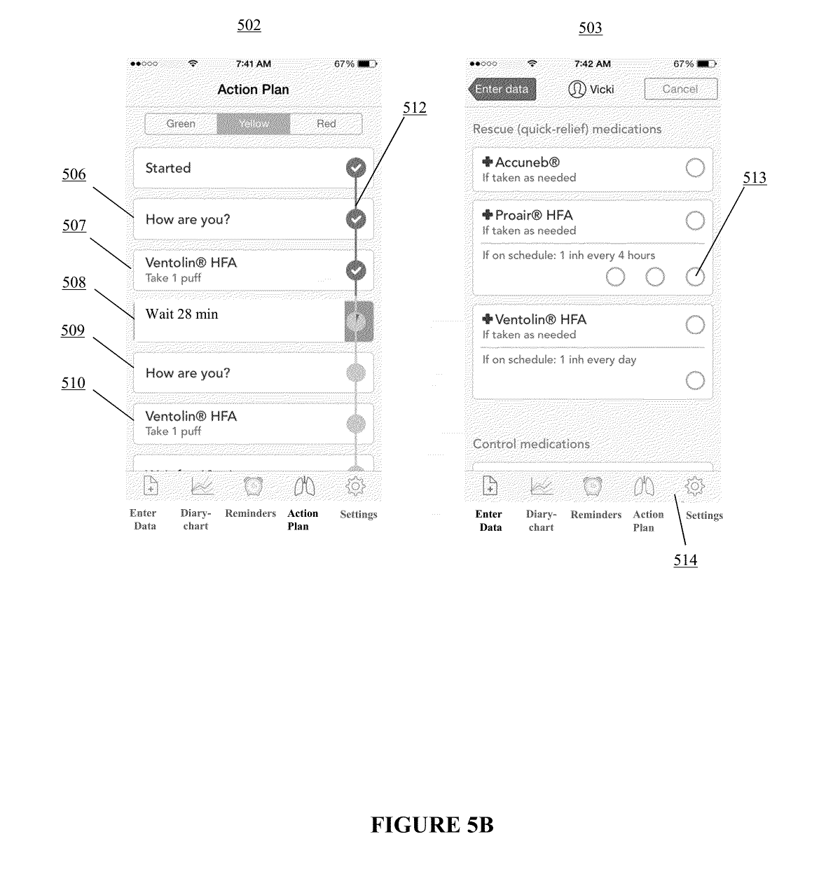

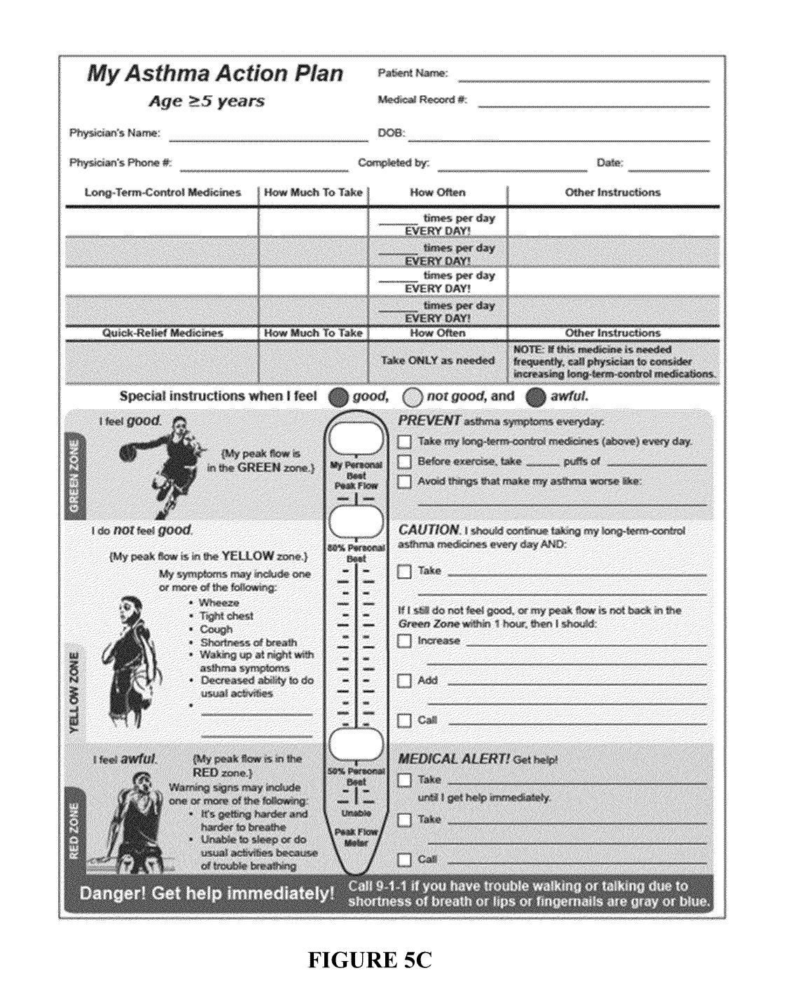

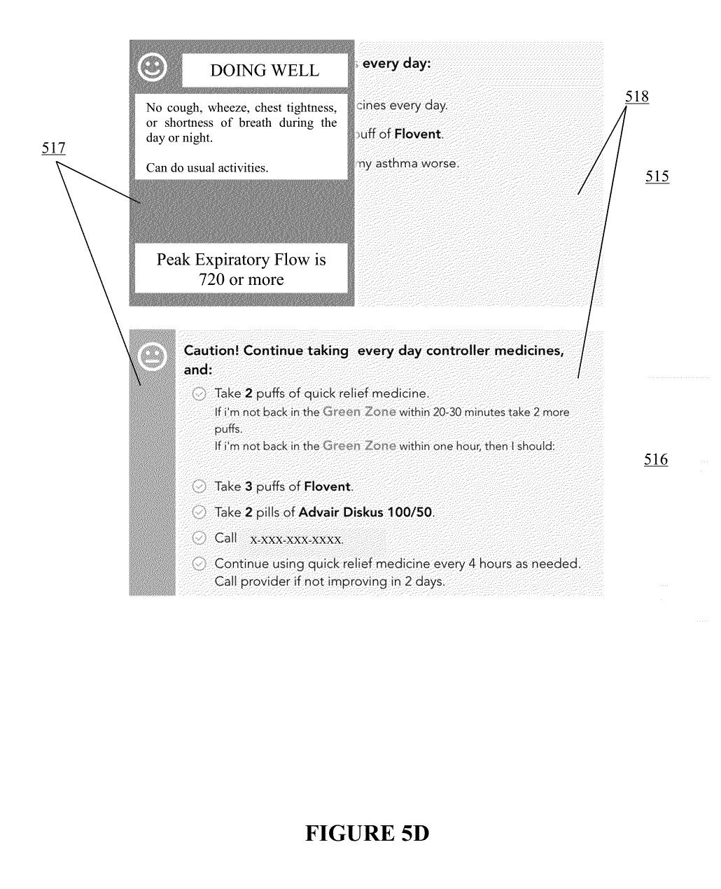

The action plan can include a plurality of zones determined by, for example, the user such as a patient together with a healthcare provider. The number of zones can be, for example, 1, 2, 3, 4, 5, 6, 7, 8, 9, 10, or more. In some embodiments, the number of zones is 3. In some embodiments, the number of zones is 4. The number of zones can be based on the level of severity of the health condition. Information provided in individual zones can follow regulations, for example, country, federal, or state regulations. In some cases, the health information, for example, prescriptions, availability, and sourcing of medications, can be subject to regulation. In some cases, the health management plan can be configured to comply with local regulations, for example, regarding the action plan, the health condition, or other factors surrounding the local healthcare system. In one example, action plan for a user in the State of Maine can be different from that of a user in the State of California. In another example, an action plan in Australia can include 4 zones, while an action plan in the United States can include 3 zones, for example, green, yellow, and red, as shown in FIG. 5C. In another example, different action plans can be substantially similar or include substantially the same information organized in a different zone configuration. Further, the information and action items included in the action plan can be subject to different regulations without substantially altering the action plan. The systems and methods of the disclosure can include a localization plan or feature, as described elsewhere herein.

Data collected with the systems and methods of the disclosure can include results of a breathing test of a subject. The breathing test results can include, for example, peak expiratory flow, spirometry readings, or a combination thereof.

The zones in an action plan can be based on a peak expiratory flow reading of a subject, for example, green zone, when the subject's peak expiratory flow reading is between about 80% to about 100% of the subject's normal peak expiratory flow reading, yellow zone, when the subject's peak expiratory flow reading is between about 50% to about 79% of the subject's normal peak expiratory flow reading, and red zone, when the subject's peak expiratory flow reading is less than about 50% of the subject's normal peak expiratory flow reading. The normal peak expiratory flow reading can be based on the peak expiratory flow measurement of the subject when the subject is in a state of good health, for example, when symptoms of the health condition are under control.

A peak expiratory flow reading can be used to monitor a subject's health condition, for example, asthma. The peak expiratory flow reading can be a measurement of a subject's ability to push air out of lungs. The peak expiratory flow reading can be measured with a peak flow meter. A peak flow meter can be a portable, hand-held device that measures the subject's maximum speed of expiration. The peak expiratory flow reading can be used, for example, to identify triggers of asthma, such as at work, home, or play; determine if asthma is getting worse before symptoms are experienced, such as by showing changes before symptoms are experienced; determine the zone into which the user's condition falls; determine whether a change in the use of medications is needed; ascertain whether or not to implement a medication plan developed for worsening asthma; determine whether a lower level of medications can be used; determine severity of an asthma episode to decide when to use quick-relief medication; determine when to seek emergency care; or any combination thereof. The systems and methods of the disclosure can include capability for sharing, for example, peak expiratory flow data, medication data, diary information and other information or data with the user's healthcare provider. The sharing of data can be accomplished, for example, with one click.

A spirometry reading can be used to manage a subject's health condition, for example, asthma, chronic obstructive pulmonary disease, and other conditions associated with improper breathing. The spirometry reading can be obtained using a spirometry device, such as a spirometer, which can measure the amount and speed of air inhaled and exhaled by a subject. The spirometry reading can be a measure of a subject's lung function and can include, for example, vital capacity (VC), forced vital capacity (FVC), forced expiratory volume (FEV), forced expiratory flow (FEF), and maximal voluntary ventilation (MVV). The forced expiratory volume can be measured at any suitable timed interval, for example, timed intervals of 0.5, 1.0, 2.0, and 3.0 seconds. In some embodiments, a forced expiratory volume in 1 second (FEV1) is used with the methods of the disclosure. In some embodiments, zones can be based on a spirometry reading of a subject.

Each zone can correspond to a set of actions to be taken by the user. For example, the action plan can include instructions about medications, such as names of medications, how much to take, and when to take, and instructions about what to do when feeling well, during asthma symptoms, and when asthma symptoms are getting worse. In some cases, medication dose, medication frequency, or both, can change depending on zone. In one example, long-term control medications, such as, anti-inflammatory medications can be taken regularly, even in the absence of symptoms. Long-term control medications can help control asthma symptoms, for example, by controlling lung swelling, decreasing mucus production, and working slowly over extended periods of time such as for hours. In another example, quick-relief medications can be taken to relieve or stop asthma symptoms once symptoms have started, or prior to activities, such as exercise, to avoid symptoms. In some cases, quick-relief medications can be inhaled and can work quickly to relax the muscles that tighten around airways. For example, a metered-dose inhaler is a self-administered quick-relief delivery device system for treating asthma, chronic obstructive pulmonary disease, and other respiratory diseases that can deliver a given amount of medication to the lungs in the form of a short burst of aerosolized medication.

The medications can be, for example, prescription-based, over the counter, or a combination thereof. For example, a weak dose of a medication can be provided over the counter while a strong dose can be prescription-based.

In some implementations, the action plan can be at least partially based on one or more measurements using a hardware component or a peripheral device. For example, an asthma action plan, such as for users with moderate to severe asthma, can be based on a peak expiratory flow reading. The peak expiratory flow reading can be used to determine the zones on an action plan. For example, the action plan can include a peak expiratory flow reading corresponding to the user's “personal best”. A user's “personal best” can be, for example, the highest peak expiratory flow reading achieved by the user in a given period. In some cases, the “personal best” peak expiratory flow reading of the user can be used, for example, by the user's healthcare provider, by the systems of the disclosure, or a combination thereof, to calculate the zones in the action plan. Each zone can correspond to a given range of peak expiratory flow readings measured by the user.

In some implementations, the action plan can be at least partially based, for example, on one or more symptoms. For example, an asthma action plan can be based on asthma symptoms. Non-limiting examples of asthma symptoms include cough, wheezing, chest tightness, shortness of breath, breathing through the mouth, difficulty breathing, trouble sleeping, frequent respiratory infections, fast breathing, hyperventilation, fast heart rate, throat irritation, chest pain, anxiety, early awakening, problems with activity level such as working, exercising or playing, changes in daytime or nighttime functions, blue lips, blue fingernails, difficulty walking, difficulty talking, and difficulty eating. The action plan can be based on asthma triggers, for example, colds, smoke, tobacco, incense, pollen, dust, animas, strong odors, mold, moisture, pests, rodents, cockroaches, stress, emotions, gastroesophageal reflux, exercise, and seasons including fall, winter, spring, and summer.

Medication management using the health management systems and methods of the disclosure can be used to obtain a prescription. For example, a prescription can be generated, such as by a user application, in less than 200, 150, 100, 75, 50, 40, 35, 30, 25, 20, 15, 10, 9, 8, 7, 6, 5, 4, 3, or 2 steps. Some of the steps can be performed automatically while others can require manual input from the user or the healthcare provider. In some examples, less than 40, 35, 30, 25, 20, 15, 10, 9, 8, 7, 6, 5, 4, 3, or 2 manual steps are required. In some cases, at least a subset of the steps can require input from a healthcare provider. In some examples, less than 10, 9, 8, 7, 6, 5, 4, 3, or 2 steps require input from a healthcare provider. In some examples, the number of steps that require input from a healthcare provider is reduced by at least 1, 2, 3, 4, 5, 6, 7, 8, 9, 10, or more steps. Healthcare provider input can be simplified to approval or denial, for example, a yes or no, instead of generation of the entire prescription. Once the prescription is obtained, the systems and methods herein can simplify the process of fulfilling the prescription, for example, by ensuring periodic and uninterrupted delivery of medication.

The systems and methods of the disclosure can be used, for example, to monitor and procure medications. For example, the action plan can include information about medications such as identity and usage. The action plan can be generated, maintained and implemented with the aid of an application. The application can comprise features to facilitate procurement of the medications. In some cases, the application can facilitate medications to be ordered or bought from one or more sources, for example, a pharmacy, a whole-sale store, or from overseas. In some cases, a discount or incentive to order can be provided to the user. For example, medication control and monitoring using the systems and methods of the disclosure can be used to secure long-term or bulk supply pricing for the user.

In some implementations, a prescription can be provided as an input to an application of the present disclosure. A prescription can be provided to the application, or fulfilled with the aid of the application, on a periodic basis, for example, a prescription-based medication can be sent to the user every month. In some implementations, a prescription can be generated as an output from the application, for example, based on one or more inputs, historical data, regulatory data, and pricing data. Prescription can be used as a basis for the action plan, and vice versa. In some examples, the prescription inputs and outputs from the system can follow or comply with a given norm.

In an example, a healthcare provider can provide an initial prescription to a user. The prescription can be received by the user via an application for a mobile or a wearable device or portal of the user, for example, using an application downloaded on an iPhone, iPad, or an Android-based phone. The user can manually, semi-automatically, or automatically fulfill the prescription by ordering the prescribed medication from one or more sellers. In some cases, the prescription can aid in managing a health condition of the user, for example, the prescription can be used in a health management plan. The user can provide one or more inputs to the health management system, and receive one or more outputs, for example, recommendations, and updated action plan from the health management system. In some cases, the user can take one or more actions as a result of the outputs. Further, in some cases, the health management system can generate one or more prescriptions or be used to place an order of a medication in accordance with the outputs. For example, a new prescription or medication recommendation based on processing steps performed by the system, such as the application, can be generated, specifying a changed dose such as a changed dose of a long-term control medication or a different medication. In some cases, the new prescription or recommendation can be provided to the healthcare provider for review and approval. In some cases, the system can be configured to allow the user to order the new medication. For example, once a new prescription is generated, or an existing prescription is renewed, the system can place an order for the prescribed medication. In another example, the system can track medication usage to predict future refill or refill interval. In some cases, the system can track medication usage to predict future refill or refill interval and place an order. In some examples, the system can calculate an estimated shipping delay, for example, to ensure timely medication availability. In some examples, the system can track and estimate an expiration date of a medication. In some cases, the system can track and estimate the expiration date of a particular medication and order refill for medication, for example, to ensure that the user does not take expired medications. Alternatively, once a new over-the-counter medication is identified, or an existing over-the-counter medication is re-validated, the system can place an order for the over-the-counter medication. The ordering step can be performed by the system with or without user input.

An aspect of the disclosure is directed to systems for health management. In some implementations, the systems of the disclosure can comprise a computer server and one or more portals, for example, a healthcare provider portal, an insurer portal, or a seller portal. In one example, a system can comprise a server with a healthcare provider portal. The healthcare provider portal can be used by a healthcare provider to access health management information of a user, such as a patient, to provide a prescription to the user, to enter the user's insurance information, and determine what insurance is covered. In some examples, one or more functions, such as entering insurance information, can be performed by the user. In some cases, a user portal can also be provided. The user portal can be implemented via an application, as described elsewhere herein, as a separate portal, for example, server-based, or both.

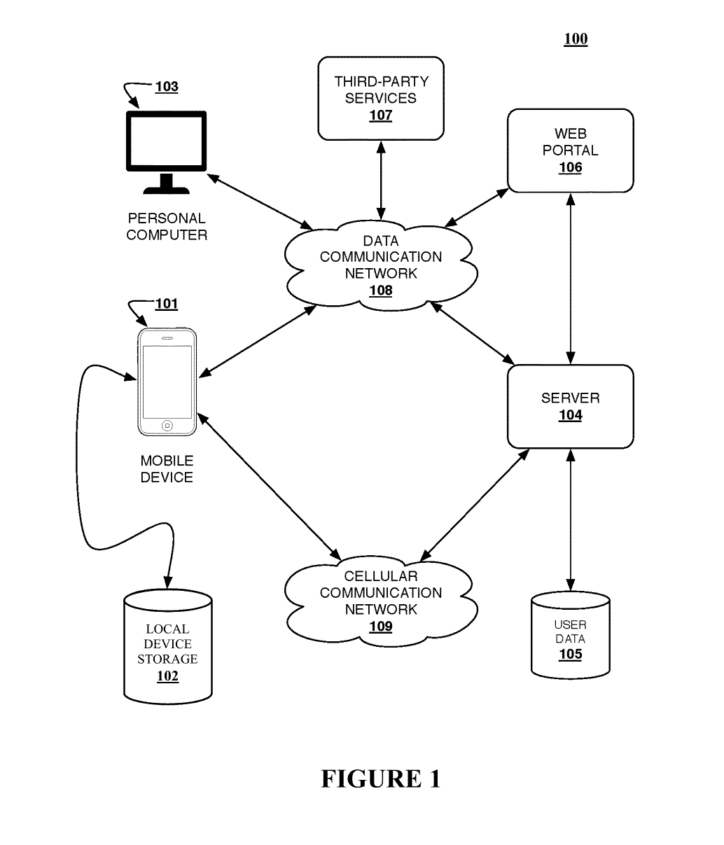

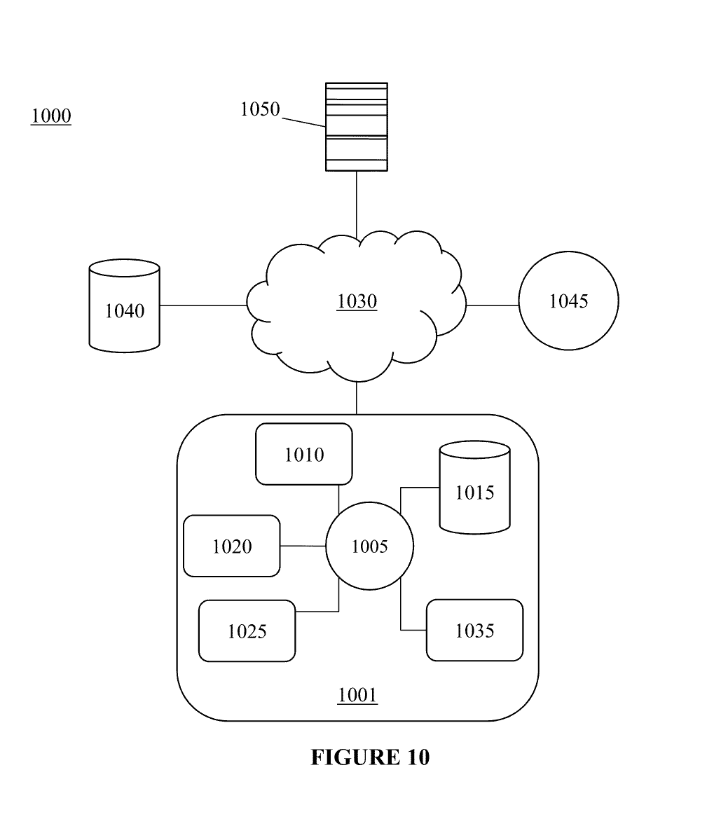

FIG. 1 schematically illustrates a system 100 comprising a health management system. The system can be implemented locally on one or more devices, over a network or in the cloud, or a combination thereof. The system can comprise or be implemented on one or more computer systems, for example, one or more computer systems 1001 in FIG. 10. Computer systems can include, for example, a personal computer (PC), a terminal, a server, a slate, tablet PC, a smart phone, a netbook, a personal digital assistant, and systems and devices with optional computer network connectivity such as video game console, television, video player, digital music player, and vehicle.

The system can comprise a mobile device 101, for example, smartphone, tablet, personal assistant, or any other device capable of communicating over a network. The system can comprise a local storage device or memory 102, such as a storage device for storage and retrieval of data and information to and from the mobile device 101. The mobile device 101 can be in communication with a cellular communication network 109. One or more components of the system 100 can communicate with one or more other systems, or one or more other components of the system 100, such as third party services 107 or other entities or systems, over a data communication network 108. For example, a personal computer 103 and the mobile device 101 can communicate over the network or networks 108. One or more web portals, for example, a physician health portal can also be in communication with the data communication network 108 and a server 104. For example, data or information communicated via the web portal 106 can be communicated to a health management system implemented, with the aid of a processor, on a device, such as, the mobile device 101. Information, for example, insurance information, sales price, and regulatory information can also be communicated via the data communication network 108, including, to and from the web portal 106, to the device 101, and to the computer 103, from the third-party services 107. The data communication network 108 can be in communication with the server 104. The server 104 can also be in communication with, for example, the cellular communication network 109, and user data storage or memory 105. In some cases, the memory location 105 can be directly in communication with the data communication network 108. In some examples, data communicated over the data communication network 108 can be processed at the server 104. The server can store or retrieve at least a portion of the data from the memory 105. Further, the server 104, which can also serve as a computing device, can perform calculations or analytical operations on the data. The processed data can then be communicated over the data communication network 108 and the cellular communication network 109 to other components of the system 100. In some cases, the server 104 can communicate with the device 101, and other components of the system 100, over the cellular communication network 109 in addition to, or instead of, over the data communication network. In some cases, communication over the communication networks 108 and 109 can be adapted depending on network access such as signal strength, bandwidth, and speed.

The system can include applications that are programmed or otherwise configured to run on one or more operating systems. In some cases, applications can perform processing or actions related to health management, for example, transform and calculate data or signals, and generate output for display to a user. In some cases, at least a portion of the processing or actions related to health management can be performed elsewhere in the system 100. For example, processing or actions related to health management can be performed at the server 104, at the computer 103, or at one or more other processing locations. In some cases, a first portion of the processing or actions related to health management can be performed by an application, for example, implemented on the device 101, and a second portion of the processing or actions related to health management can be performed elsewhere in the system 100.

The system 100 can be configured to provide access to one or more users, for example, patients and healthcare providers. For example, the user can access the health management system at the device 101, at the computer 103, or via the web portal 106. In some cases, third party service providers can be given user access. In some cases, the user access comprises different access levels, for example, patient level, healthcare provider level, and third party level. Different user access points can include similar functionality or features. In one example, user access via the device 101 can include similar functionality as user access via the computer 103. In another example, user access via the web portal can offer limited functionality compared to at least one other user access point of the system 100. In another example, user access using the mobile device 101 can include enhanced features compared to other user access points.

FIG. 10 shows a system 1000 comprising a computer system or server 1001. The server 1001 includes a central processing unit (CPU) 1005, which can be a single core or multi core processor, or a plurality of processors for parallel processing. The server 1001 also includes memory 1010, for example, random-access memory, read-only memory, and flash memory; electronic storage unit 1015, for example, hard disk; communication interface 1020, for example, network adapter, for communicating with one or more other systems; a display interface 1035, for example, display adapter; and peripheral devices 1025, such as cache, other memory, data storage and electronic display adapters. The memory 1010, storage unit 1015, interfaces 1020 and 1035, and peripheral devices 1025 are in communication with the CPU 1005 through a communication bus, depicted in solid lines in FIG. 10, such as a motherboard. The storage unit 1015 can be a data storage unit or data repository for storing data. The server 1001 can be operatively coupled to a computer network 1030, for example, data communication network 108 and cellular communication network 109, with the aid of the communication interface 1020. The network 1030 can be, for example, the Internet, an internet and extranet, or an intranet and extranet that is in communication with the Internet. The network 1030 in some cases is a telecommunication and data network. The network 1030 can include one or more computer servers 1050, and one or more processing units 1045, which can facilitate distributed computing, such as cloud computing. Further, the network 1030 can include one or more data storage units or memory locations 1040. The network 1030, in some cases with the aid of the server 1001, can implement a peer-to-peer network, which can allow devices coupled to the server 1001 to behave as a client or a server.

The server 1001 can include an operating system with a program that is configured to interface with a device, such as a display device, a hardware component, and a peripheral device. The server 1001 includes applications for permitting a user to perform various user-specific functions in the context of health management. The system 1001 can have software that is configured to operate on various operating systems, such as Linux-based operating systems, Windows-based operating systems, or any other operating system described herein. The operating system can reside on a memory location of the system 1001. In some cases, the operating system can be provided by cloud computing.

The system 1000 can be adapted to interface with various entities or systems associated with such entities, such as, for example, a third party service provider or a system associated with a third party service provider, a medical or physician network provider or a system associated with a medical or physician network provider, or a user or a system associated with a user. The systems associated with entities can include computer systems. In some situations, the communications interface 1020 facilitates the system 1001 to interface wirelessly with the network 1030. In such a case, the communications interface 1020 includes a wireless interface, for example, 2G, 3G, 4G, long term evolution (LTE), Wi-Fi, and Bluetooth that brings the system 1001 in wireless communication with a wireless access point that is in communication with the network 1020. The communications interface 1020 can facilitate the system 1001 to collect information from various sources, for example, information from third party service providers.

A user interface (UI) can allow a user to interact with systems of the disclosure, for example, for managing a health condition of the user. The UI, such as a graphical user interface (GUI), having various graphical, textual, audio, and video elements, can be provided on a display of a device of the user, for example, device 101. In some cases, the UI can be provided on a display of a user terminal or a healthcare provider terminal. The display can be integral to the device or terminal, for example, a smartphone display, or provided separately, for example, as a computer monitor. In some cases, the display can be a display device, and vice versa. Any aspects of the disclosure described in relation to display devices can equally apply to displays at least in some configurations.

In some examples, the user interface can be provided through client software. The systems of the disclosure can include a computer program having a sequence of instructions, executable by a processor, written to perform a specified task. Computer readable instructions can be implemented as program modules, such as functions, objects, Application Programming Interfaces (APIs), and data structures that perform particular tasks or implement particular abstract data types. The functionality of the computer readable instructions can be combined or distributed in various environments, for example, one or more locations, one or more software modules hosted on one or more computer systems or cloud computing platforms, one or more web applications, one or more mobile applications, one or more standalone applications, one or more web browser plug-ins, extensions, add-ins, or add-ons, and combinations thereof. In some examples, the user interface is a web-based user interface that is configured, for example, programmed, to be accessed using an internet or web browser of a computer system of the user, for example, device 101, and computer 103. The user interface can allow individual users to access information, for example, information associated with a custom access level, which can be stored locally, for example, on the device 101 of the user, or on a local storage device 102, or remotely, for example, in the user data storage or memory location 105, by third party service provider 107, or by another entity interacting with the system 100, such as a medical records system.

Aspects of systems and methods described herein can be implemented with the aid of a computer processor, for example, CPU 1005, or implemented as functionality programmed into any of a variety of circuitry, including programmable logic devices (PLDs), such as field programmable gate arrays (FPGAs), programmable array logic (PAL) devices, electrically programmable logic and memory devices, and standard cell-based devices, as well as application specific integrated circuits (ASICs). Some other possibilities for implementing aspects of the systems and methods include, for example, microcontrollers with memory, embedded microprocessors, firmware, and software. Furthermore, aspects of the systems and methods can be embodied in microprocessors having software-based circuit emulation, discreet logic, which can include, sequential and combinatorial, custom devices, fuzzy logic, neural network, quantum devices, and hybrids of any of the above device types. The underlying device technologies can be provided in a variety of component types, for example, metal-oxide semiconductor field-effect transistor (MOSFET) technologies, such as, complementary metal-oxide semiconductor (CMOS); bipolar technologies, such as, emitter-coupled logic (ECL); polymer technologies, such as, silicon-conjugated polymer, and metal-conjugated polymer-metal structures; and mixed analog and digital technologies.

The various functions and processes disclosed herein can be described as data as well as instructions embodied in various computer-readable media, in terms of their behavioral, register transfer, logic component, transistor, layout geometries, and other characteristics. The data and instructions can be embodied in non-transitory tangible computer-readable media. Computer-readable media, in which such formatted data and instructions can be embodied, include, but are not limited to, non-volatile storage media in various forms, for example, optical, magnetic, or semiconductor storage media, and carrier waves that can be used to transfer such formatted data and instructions through wireless, optical, or wired signaling media, or any combination thereof. Examples of transfers of such formatted data and instructions by carrier waves include transfers, such as uploads, downloads, and email over the Internet or other computer networks via one or more data transfer protocols, for example, TCP, UDP, HTTP, FTP, and SMTP. When received within a computer system via one or more computer-readable media, such data and instruction-based expressions of components or processes under the systems and methods can be processed by a processing entity, for example, one or more processors, within the computer system in conjunction with execution of one or more other computer programs.

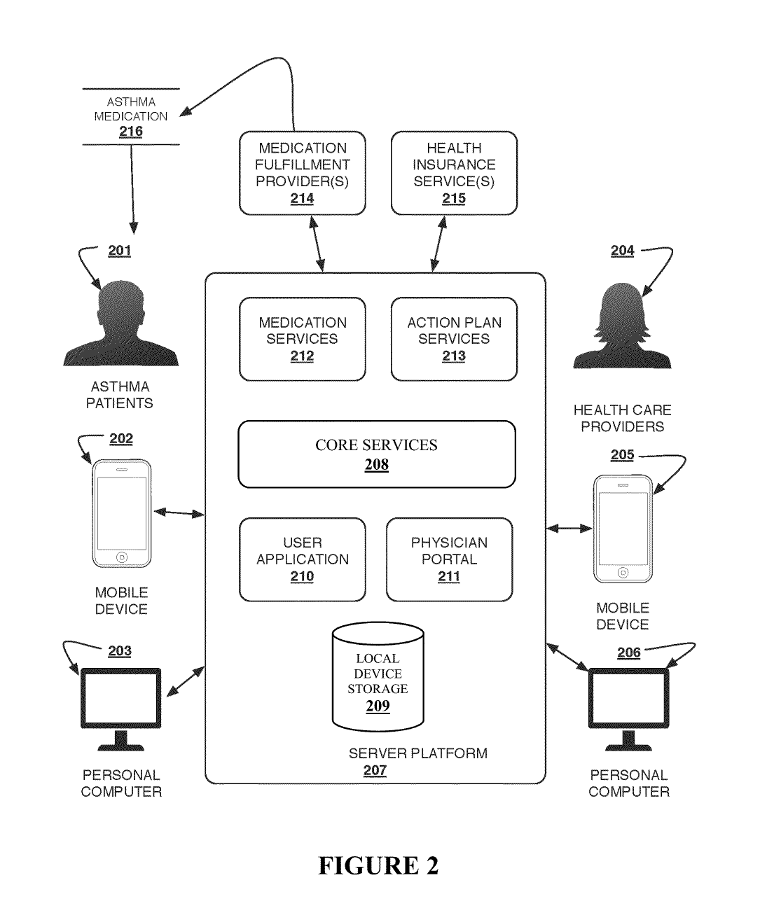

FIG. 2 is an example of a computer server-based health management system. The health management systems, such as the health management software or programs, of the disclosure can include various health management services. In some cases, the health management services can be provided as features within a software application or program. In some cases, the health management services can be provided as separate health management applications.

The health management system can comprise a computer server platform 207. The server platform 207 can include local device storage 209, a user application 210, for example, a smartphone application or “app”, and a healthcare provider portal 211. The server platform can further comprise one or more health management core service 208. In some examples, the core services can include one or more services, for example, interconnecting one or more components, such as action plan services 213 to medication services 212, disease-specific logic such as for asthma and diabetes, configuration, and algorithms. The health management system, for example, the server platform, can comprise one or more medication services 212, and one or more action plan services 213. The server platform can be configured to interact, for example, over a communications network, with one or more entities, such as medication fulfillment provider 214 and health insurance services 215. Entities can further include users. The server platform can be configured to interact with one or more users and healthcare providers. In some examples, users include patients 201, for example, asthma patients. The patients 201 can interact with the platform using, for example, the user application 210. In some examples, users can include healthcare providers 204. In some examples, healthcare providers can be entities but not users. The healthcare providers can interact with the platform using, for example, the healthcare provider portal 211. The healthcare provider portal can provide user rights to the healthcare provider.

In some implementations, the patients 201 and the healthcare providers 204 can interact with the health management platform 207 via mobile devices 202 and 205, respectively. In some implementations, the patients 201 and the healthcare providers 204 can interact with the health management platform 207 via personal computers 203 and 206, respectively. In some implementations, the patients 201 and the healthcare providers 204 can interact with the health management platform 207 via both mobile devices and personal computers.

In some cases, individual applications, modules, and services can be configured to interact with a subset of the entities, users, patients, and healthcare providers. Alternatively, one or more individual applications, modules, and services can be configured to interact with all of the entities, users, patients, and healthcare providers. In one example, the medication fulfillment provider 214 can interact with the server platform 207 via the medication services 212 only. In another example, the medication services 212 can be configured to interact with the medication fulfillment provider 214, as well as with users, patients, and healthcare providers. In some cases, users, patients, and healthcare providers can interact with multiple services and applications. For example, patients can use the asthma core services 212, the action plan services 213 to create an action plan, and the medication services to place an order for a medication 216. In some implementations, individual modules and services can be configured to be accessed by individual applications, portals, and external entities. The access can be modular such that modules and services can be selectively implemented, added, or removed.

Another aspect of the disclosure provides methods for health management. The methods can be implemented as part of applications, modules, and services implemented on the systems described herein. In some cases, the methods can be used to interact with entities, users, patients, and healthcare providers. In some implementations, one or more steps of the methods herein can be performed in a different order. Further, one or more steps can be added or removed.

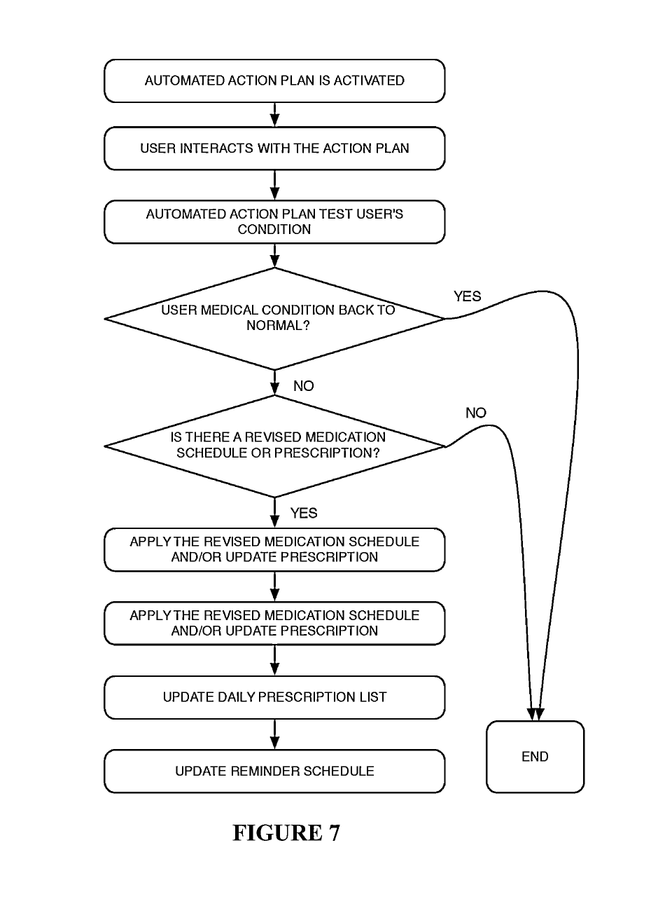

FIG. 7 schematically illustrates a method for updating a health management system. In a first step, an automated action plan is activated. In a second step, a user interacts with the action plan. In a third step, the automated action plan tests the user's condition, for example, health condition. If the user's medical condition is back to normal, the process is terminated. If the user's medical condition is not back to normal, the system determines whether a revised medication schedule or prescription exists. If not, then the process ends. If yes, then the revised medication schedule is applied and the prescription is updated. Next, a daily prescription list is updated. In a further step, a reminder schedule is updated. The process can be repeated iteratively or periodically. In some cases, the process can be repeated until the end condition is achieved.

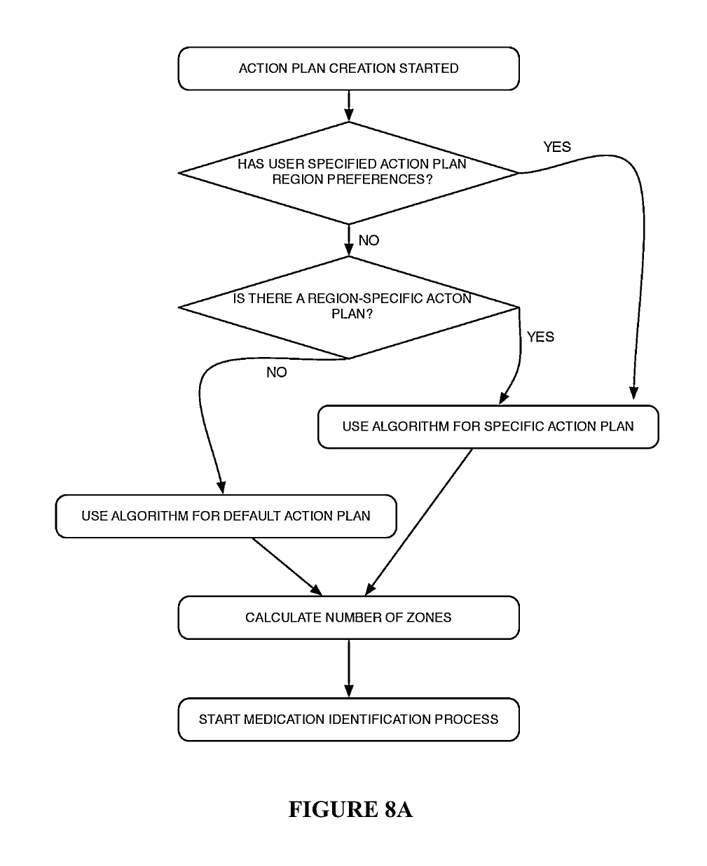

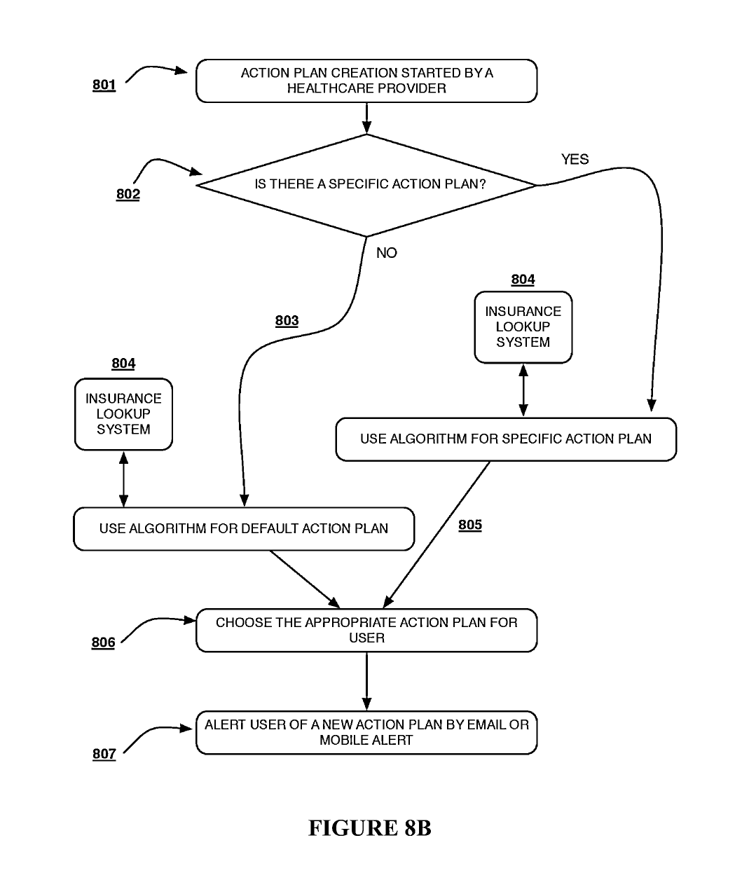

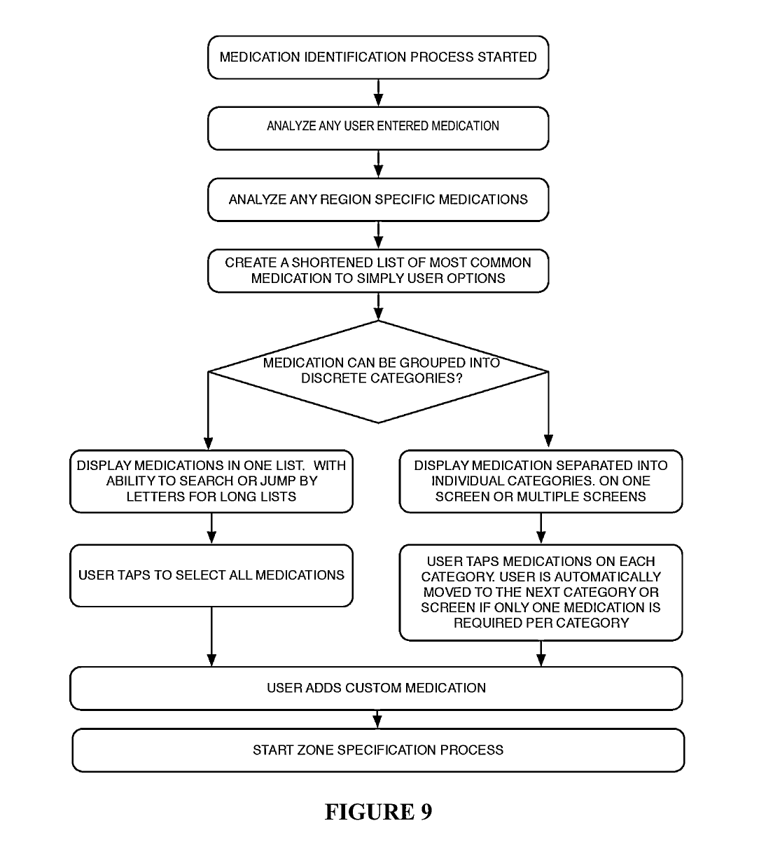

FIG. 8A schematically illustrates a method for creating an action plan. The method includes starting action plan creation, and determining whether a user has specified action plan region preferences. If the user has specified action plan region preferences, the method can include using an algorithm for a specific action plan. If the user has not specified action plan region preferences, the method can determine whether a region-specific action plan exists. If yes, then the method can use an algorithm for a specific action plan. If not, then an algorithm for a default action plan can be used. Next, the number of zones, for example, action plan zones can be calculated. In a further step, a medication identification method or process, for example, the medication identification process shown in FIG. 9, can be started.

FIG. 8B schematically illustrates an example of a method for interacting with a health management system to create an action plan. The method can be used by a healthcare provider to create an action. The action plan can be, for example, an asthma action plan (AAP). In some cases, a healthcare provider can create the action plan, for example, the AAP, after receiving an email notification from a user requesting the action plan. In some cases, the creation of the action plan, for example, the AAP, can be directly initiated by the healthcare provider in 801. In some cases, the action plan can be initiated using the healthcare provider's third-party electronic medical record (EMR) or electronic health record (EHR) system, which then communicates with the health management system. In some cases, the action plan can be initiated by an integrated configuration of the health management system inside the third-party electronic health record or electronic medical system. In some cases, the health management system can be stand-alone. In some cases, the health management system can communicate with the healthcare provider's electronic medical record or electronic health record systems. In some cases, the system can store existing configuration of one or more action plans, for example, pre-configured by the healthcare provider. The system can investigate the existence of an action plan, for example, an existing action plan or a pre-configured action plan, in 802. In one example, if an action plan exists, then the system can use an algorithm for a specific action plan. In another example, if no action plan 803 exists, then the system can use an algorithm for a default action plan. In some cases, one or more action plans can be stored, manually or automatically, based on the healthcare provider's past prescribed action plan. In some cases, the pre-configured action plans can be specifically pre-configured by the healthcare provider, such as prior to creation of a given action plan. In some cases, for example, when no history exists from the healthcare provider, the system can display a list of pre-configured action plan recommendations. In some cases, these recommendations can be based on recommendations of the National Institutes of Health (NIH) or a national health organization or authority for a specific region or country. In some cases, the recommendations can be based on one or more action plans managed by the system, for example, most popular action plans on the system globally, targeted for a specific region, or targeted for a specific age, sex, or demographic. In some examples, such as when the system identifies a specific action plan, the healthcare provider can start with one of the action plans on the system, such as the recommended action plans, and then customize the action plan in 805. In some cases, the system can use an algorithm to process and check an insurance database, for example, user's specific insurance database, to suggest formulary options for the user's insurance coverage, for example, using an insurance lookup system 804. In some cases, the system can use an algorithm to process and check an insurance database, for example, a user's specific insurance database, to suggest formulary options for the user's insurance coverage, for example, using an insurance lookup system 804, as well as best practices guidelines as recommended by the NIH and other organizations, such as in step 803 when the system determines no specific action plan exists, and in step 805. In some cases, the system can track customization and modifications to the action plan and store the action plan, for example, as a pre-configured action plan to be used by the user or healthcare provider at a later date in the future. The system can select a suitable and appropriate action plan. Once the action plan, for example, the AAP, has been selected, the application can use algorithms to create specific steps in the action plan. In some implementations, the steps in the action plan can be editable, for example, by the user and the healthcare provider, for further customization of the action plan to meet the needs of specific users 806, such as patients. The healthcare provider can then assign the action plan to a specific patient or user. In some cases, the system can alert the user of the updated action plan, for example, via email or mobile notification or alert. For example, the system can automatically display the updated action plan to the user or patient in 807. In some cases, the user or patient can confirm and accept the action plan. In some cases, the system can update, manually or automatically, all medications and reminders to match the action plan, for example, the specific action plan.

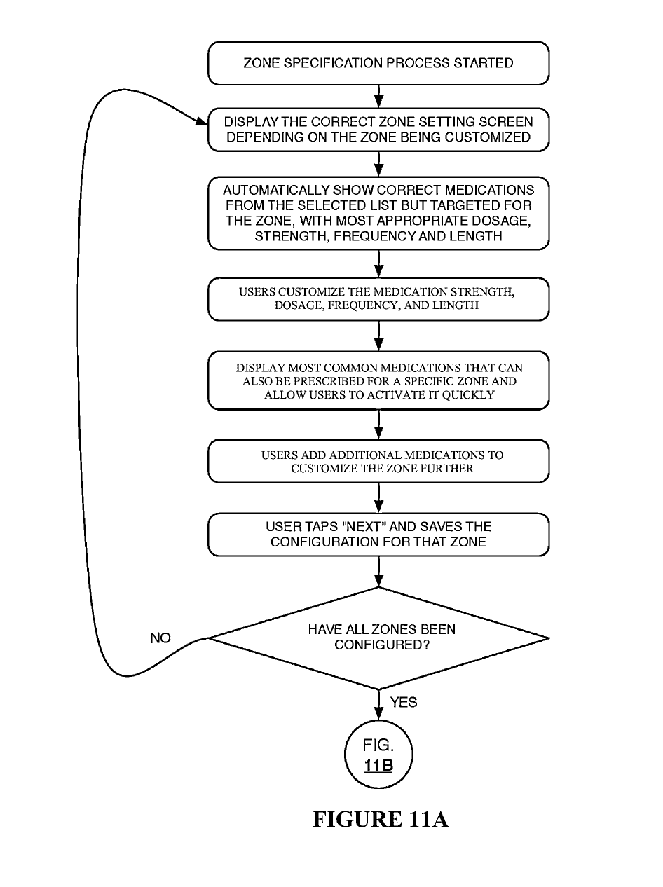

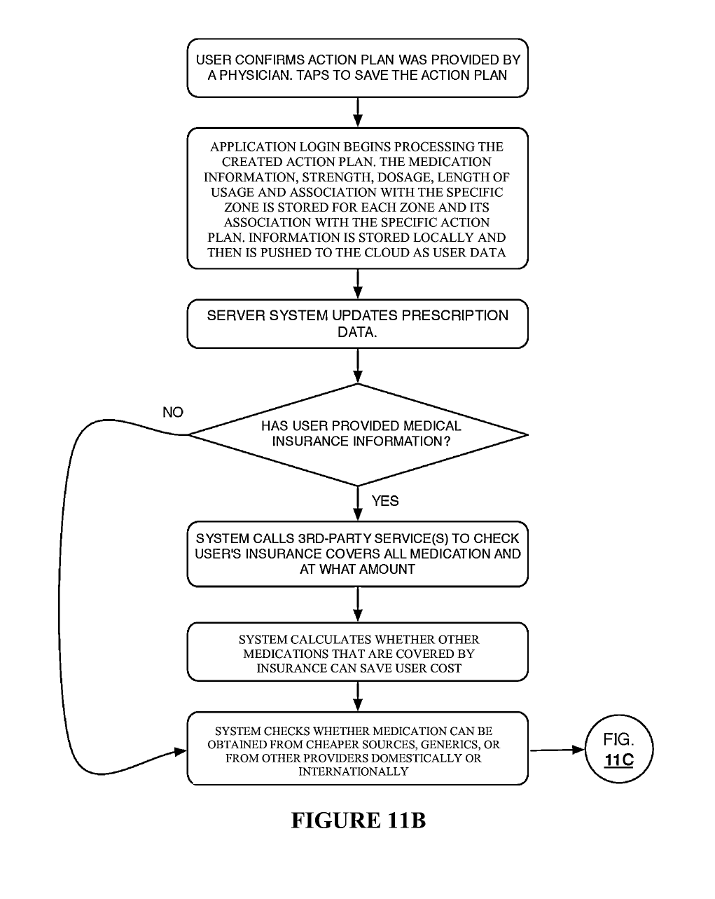

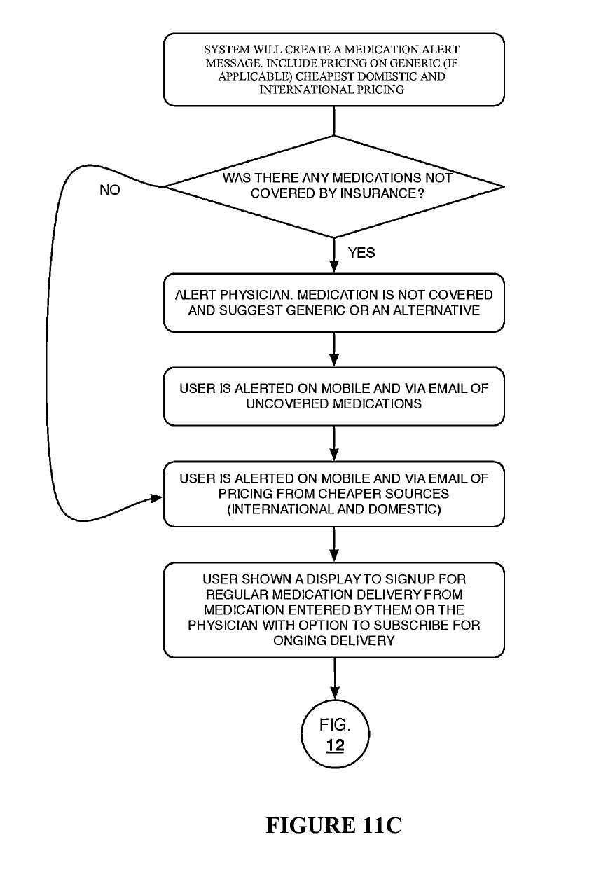

FIG. 9 is an example of a method for identifying medication. The method can include starting a method identification process, analyzing any user entered medication, analyzing any region specific medications, and creating a shortened list of most common medications in order to simplify user options. Next, the method can determine whether medications can be grouped into discrete categories. In some implementations, the medications can be displayed in one list. Ability to search or jump by letters for long lists can be provided. The user can then tap to select all medications, or a subset of medications. In some implementations, the medications can be displayed separately. For example, the medications can be separated into individual categories, such as quick-relief medications, long-term control medications, prescription medications, over-the-counter medications, and medications available for purchase from abroad. The individual categories can be displayed on one screen or on multiple screens. The user can tap to select one or more medications in each category. If only one medication is required per category, then the user can automatically advance to the next category or screen. Further, the user can add custom medication. Next, a zone specification method or process, for example, zone specification process shown in FIG. 11A, can be started.

FIG. 11A schematically illustrates a method for specifying zones. After the zone specification method is started, the method can display a zone setting screen corresponding to a zone being customized. The method can further include automatically showing medications from a selected list, for example, a list selected in the medication identification method in FIG. 9, targeted for the specified zone. The medications can be displayed together with information or parameters, for example, appropriate dosage, strength, frequency, and length of usage. In some cases, a user can customize one or more parameters, for example, the medication strength, dosage, frequency, and length. The method can include displaying common medications that can also be prescribed for a specific zone. The user can be allowed to activate one or more of the displayed common medications, for example, to facilitate or speed up selection. The users can add additional medications to customize the zone further. The user can tap “next.” The configuration for that zone can thereby be saved. The system can then determine whether all zones are configured. If zones are not configured, then the process can restart by displaying a zone setting screen corresponding to the next zone being customized. The iteration continues until all zones have been configured. The method can then proceed to the steps in FIG. 11B.

FIG. 11B schematically illustrates a method for specifying prescription and insurance information. In a first step, a user can confirm that an action plan is provided by a healthcare provider. In some cases, the user can tap to save the action plan. In a next step, application logic can begin processing the created action plan. Using, for example, information processed using the method in FIG. 11A, medication information, strength, dosage, length of usage, and association with a specific zone can be stored for each zone. Further, association of the zone with the action plan can be identified and stored. In some cases, the information can be stored locally and then pushed to the cloud as user data.

Next, a server system can update prescription data. If the user has provided medical insurance information, then the system can call one or more third party services to check whether the user's insurance covers the medication and at what amount. The system can also calculate whether other medications exist that are covered by insurance and that can provide savings for the user. The system then checks whether medication can be obtained from cheaper sources, for example, generic versions, or from other providers domestically or internationally. If the user has not provided medical insurance information, then the method proceeds directly to checking whether medication can be obtained from cheaper sources. The method can then proceed to the steps in FIG. 11C.

FIG. 11C schematically illustrates a method for specifying medication pricing. The system can create a medication alert message. The medication alert message can include generic pricing, if applicable, domestic pricing, such as cheapest domestic, and international pricing. If any medications are not covered by insurance, for example, the user's insurance, then the method can include alerting the healthcare provider that the medication is not covered. In some cases, the method can suggest a generic or alternative medication. The user can be alerted, for example, on mobile and via email, of uncovered medications. The system can be customized to eliminate performing the preceding steps if the medications are not covered by insurance.

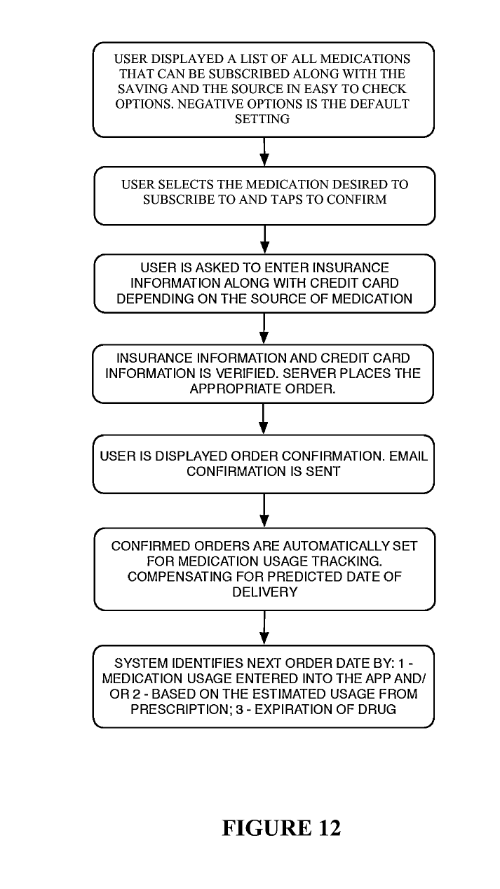

In a next step, the user can be alerted, for example, on mobile and via email, of pricing from cheaper sources, such as, international and domestic. Further, a display can be provided to the user for signing up for regular delivery of medication entered by the user or the healthcare provider. In some cases, the user can be provided with an option to subscribe for ongoing delivery. The method can then proceed to the steps in FIG. 12.

FIG. 12 schematically illustrates a method for ordering medication. In a first step, a list of all medications that a user can subscribe can be displayed to the user. The displayed information can include savings and sources of the medications, for example, as easy-to-check options. In some cases, negative options can be a default setting, for example, such that the medications are delivered in perpetuity. In some cases, users can opt for a one-time purchase instead. In some cases, such users can be reminded again to switch to a subscription plan. The user can select the medication to which the user wants to subscribe. In some cases, the user can tap to confirm the selection. Next, the user can enter insurance information and billing information, for example, a credit card number. The entered insurance and billing information can depend on the source of the medication, for example, vendor, and country of the vendor. In a next step, the insurance and billing information is verified, and the server places an order. In some cases, an order confirmation is displayed to the user. In some cases, an email confirmation is sent to the user. Confirmed orders can automatically be configured or set for medication usage tracking. In some cases, the method can include compensating for predicted date of delivery. The system can identify a next order date. In some examples, the system can identify the next order date based on medication usage entered into the system, for example, into an application. In some examples, the system can identify the next order date based on estimated usage from prescription. In some examples, the system can identify the next order date based on the expiration date of the medication.

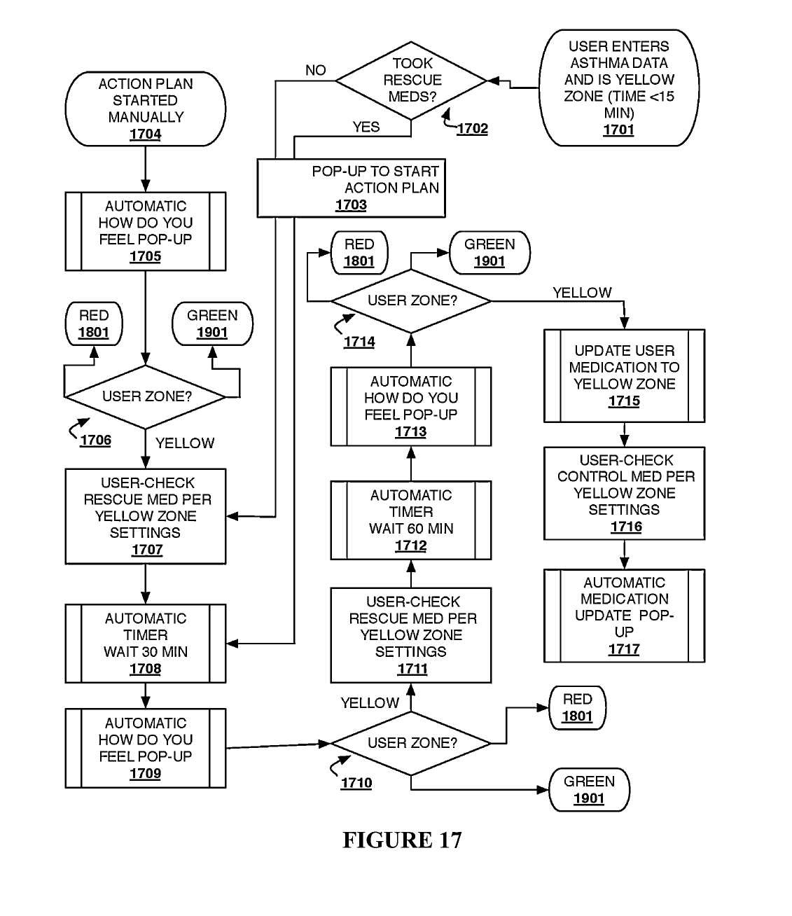

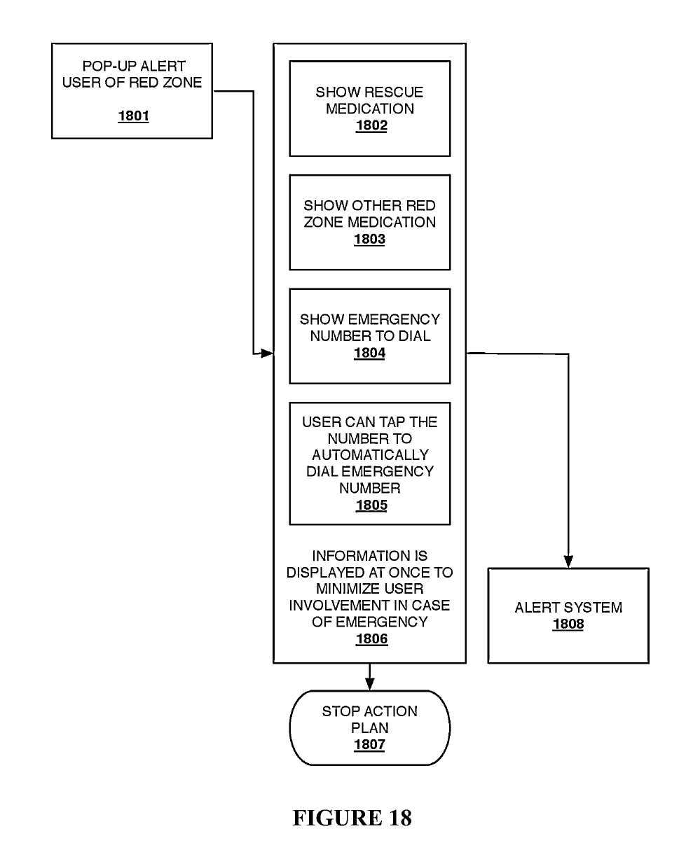

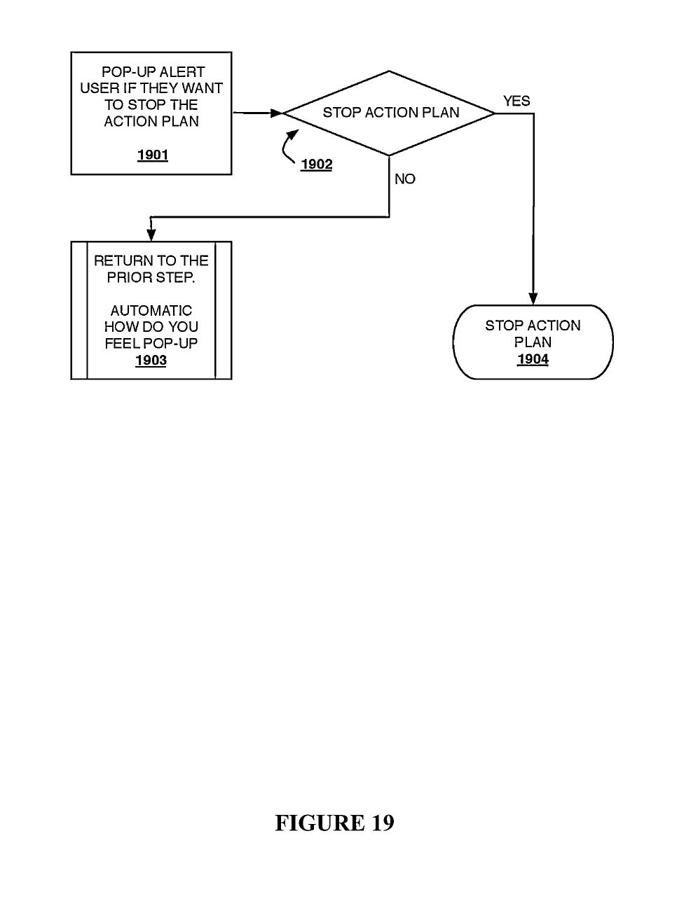

FIGS. 17-19 schematically illustrate examples of methods for interacting with a user via an interactive action plan, such as the interactive action plans in FIG. 5A-5B. FIG. 17 shows an example of a method for an action plan in a yellow zone. FIG. 18 shows an example of a method for an action plan in a red zone. FIG. 19 shows an example of a method for an action plan in a green zone.

In FIG. 17, an action plan can be started manually, for example, by the user, in 1704. In some implementations, the user can jump one or more steps. For example, if the user has asthma issues and has already taken the asthma quick-relief medication, the user can jump to step 1708 and activate the action plan by starting a timer. In another example, the user can jump directly to later steps, such as, step 1713, if the user has already taken one or more steps, other steps, or one or more of previous steps, on their own but wants to use the interactive action plan for one or more remaining steps.

In 1705, the system can automatically generate, a prompt or pop-up inquiring how the user feels, for example, “how do you feel?” or “how are you?”. The system can then determine user zone 1706, for example, at least partially based on the information input in 1705. In this example, the system determines that the user zone is yellow. In other examples, a red zone 1801, for example, as shown in FIG. 18, or a green zone 1901, for example, as shown in FIG. 19, can be determined. The user input in 1705 and the zone determination in 1706 can motivate administration of a first medication, for example, in accordance with the action plan for the yellow zone.

Alternatively, the action plan can be started as a result of one or more user inputs. In 1701, the user can enter health data, for example, asthma data, and the system determines, for example, at least partially based on the input data, that the user is in the yellow zone, for example, based on peak expiratory flow values, one or more spirometry readings such as forced vital capacity and forced expiratory volume in 1 second, symptoms associated with the yellow zone, or a combination thereof. In some cases, date or time, such as diary time, of a medical event, for example, when symptoms are observed, or when a peak expiratory flow value is captured, can be input. In some cases, when the action plan is time-sensitive or when users decide to enter past data from memory or from other sources, for example, paper notes, diaries or medical records, the system can ignore the user input under given circumstances. For example, the system can ignore the user input if the diary time predates a given, defined, or predetermined threshold or time metric, for example, older than 90 minutes. In some cases, the system can alter the action plan logic. For example, if the diary time or age of the diary entry is above a first threshold, such as more than 30 minutes in the past, but below a second threshold, such as less than 60 minutes in the past, the system can calculate a projected step and jump to a suitable or projected step, for example, step 1709. Next, the system can inquire in 1702 whether the user has taken medications, for example, quick-relief medications. If the answer is no, then the user can be prompted to administer the first medication, and the system can proceed to step 1707. If the answer is yes, the system can proceed to step 1708. A notification or prompt to start the action plan, for example, automatically, or upon user confirmation, can be displayed 1703.

Next, the user can check that administration of the first medication, for example, a quick-relief medication per yellow zone settings is complete 1707, similar to user-check 507 in FIG. 5A-5B. A first timer, similar to automatic timer 508 in FIG. 5A-5B, can be displayed for a given period of time, for example, wait 30 minutes 1708. The system can again generate a prompt or pop-up inquiring how the user feels 1709. In 1710, the system can again determine user zone, for example, at least partially based on the information input in 1709. In this example, the system determines that the zone is yellow. Alternatively, the system can determine that the zone is red 1801, for example, as shown in FIG. 18, or green 1901, for example, as shown in FIG. 19. The user input in 1709 and the zone determination in 1710 can motivate administration of a second medication, for example, in accordance with the action plan for the yellow zone.

The user can then check that administration of the second medication, for example, a quick-relief medication per yellow zone settings is complete 1711, similar to user-check 510 in FIG. 5A-5B. A second timer can be displayed for a given period of time, for example, wait 60 minutes 1712. Another prompt or pop-up inquiring how the user feels can be generated automatically in 1713. User zone 1706 can be determined again at 1714, for example, at least partially based on the information input in 1713. In this example, the system determines that the zone is yellow. Alternatively, the system can determine that the zone is red 1801, for example, as shown in FIG. 18, or green 1901, for example, as shown in FIG. 19.

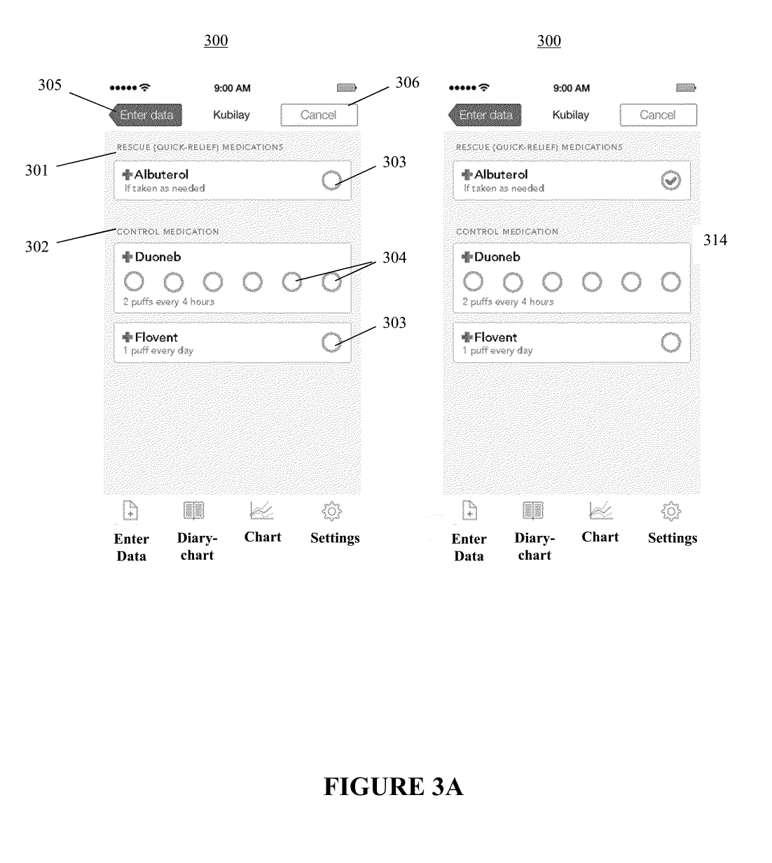

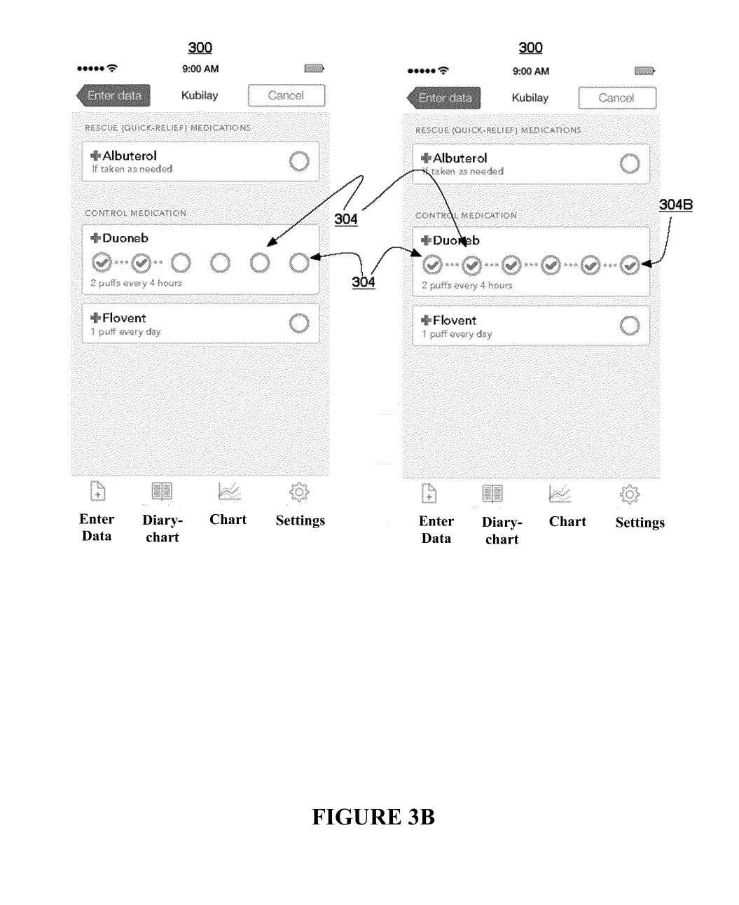

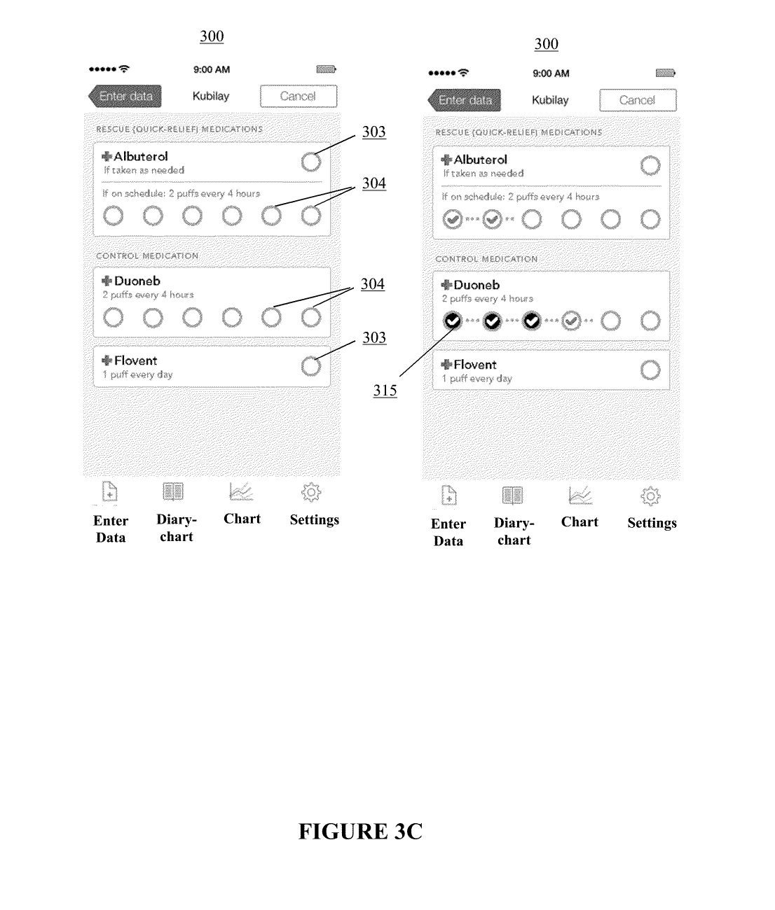

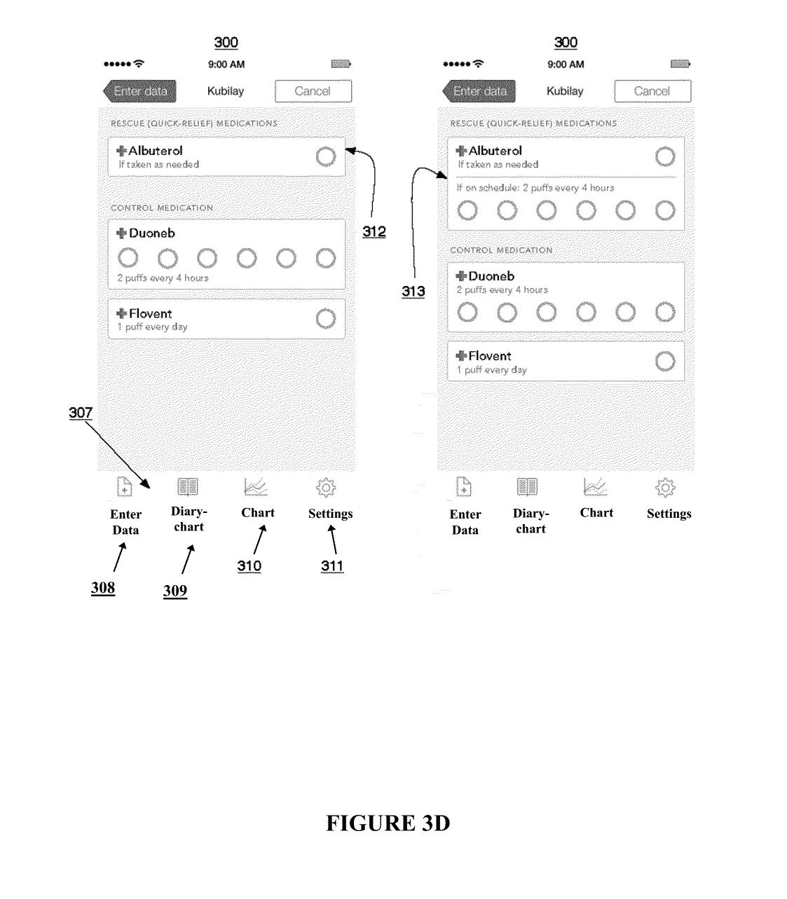

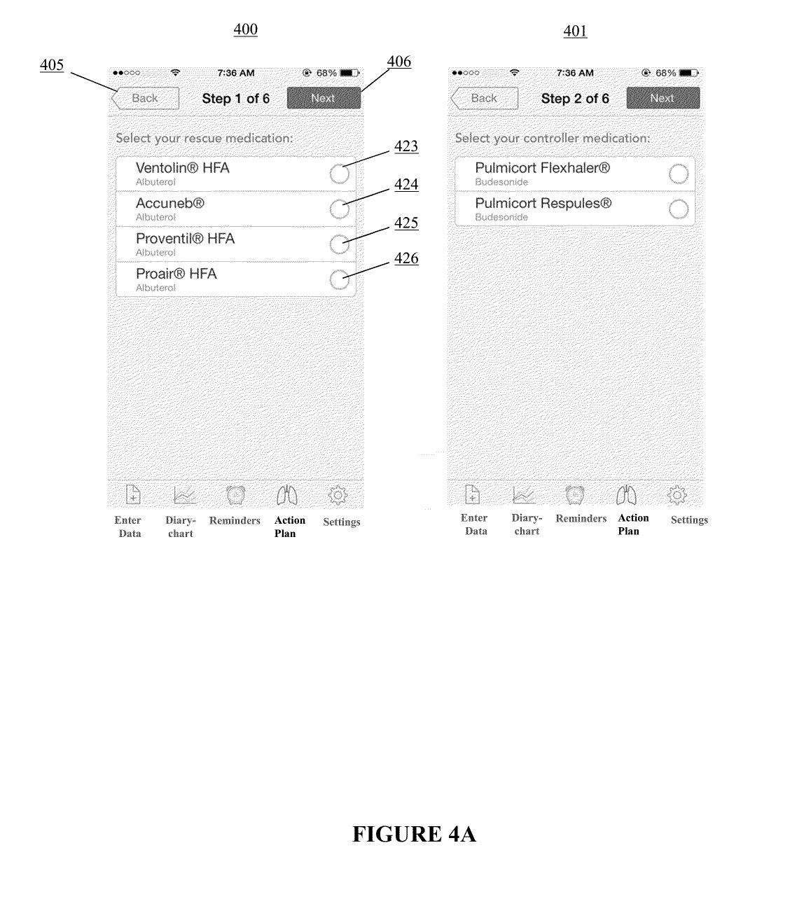

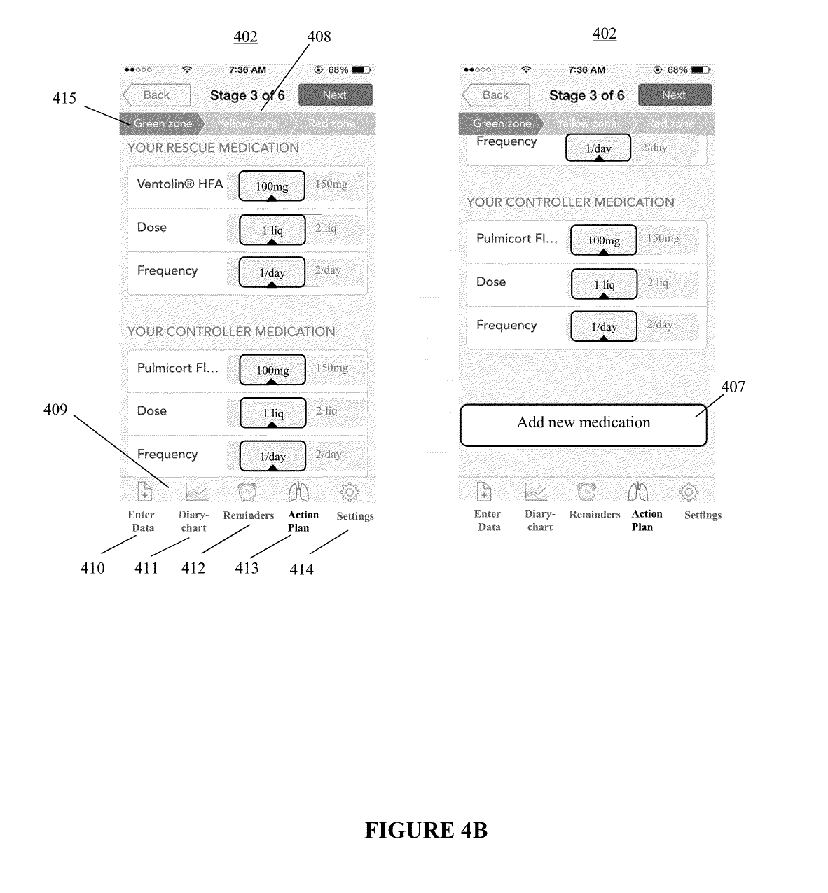

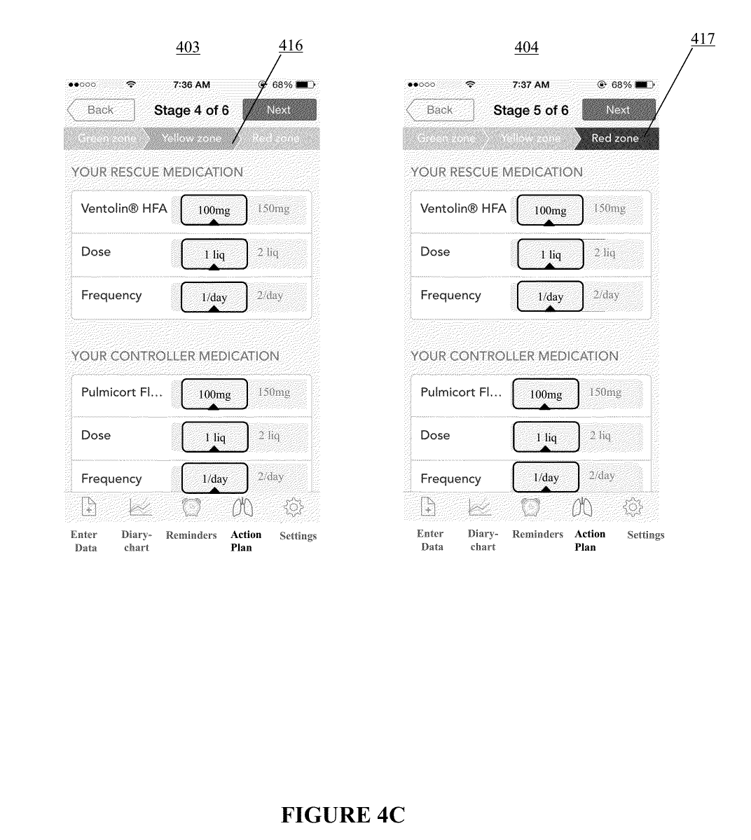

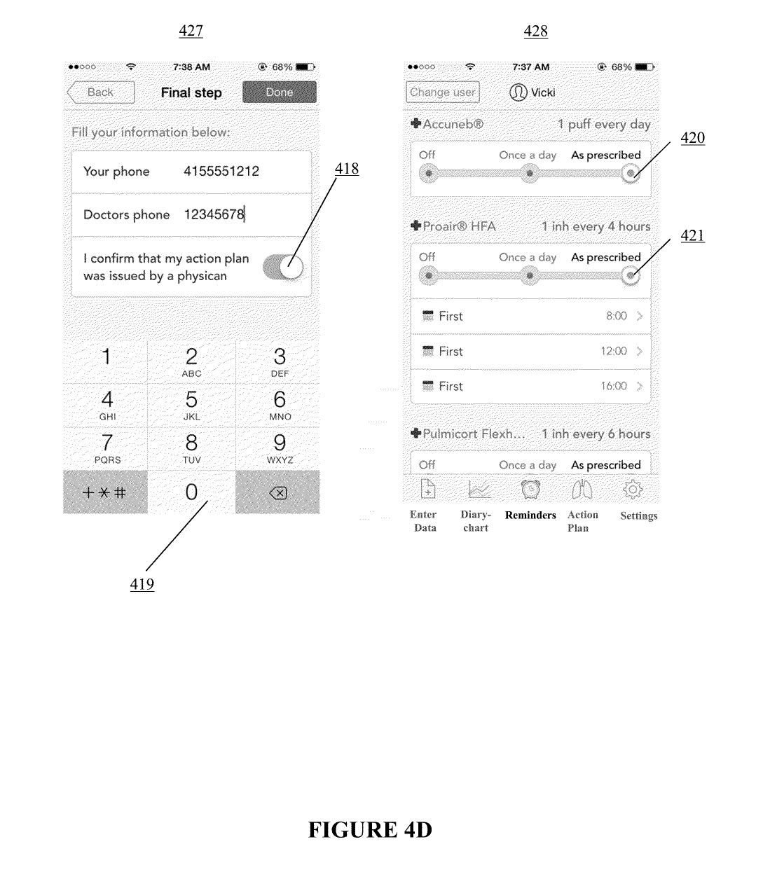

Based on, for example, the user input in 1713, or the zone determination in 1714, or a combination thereof, the system can update user medication to yellow zone in 1715. In some examples, the system can update in parallel, a user interface, for example, the GUI 300 in FIG. 3D. For example, the system can change albuterol from an as-needed basis 312 in FIG. 3D to a daily schedule 313, or add to a daily schedule 313 in addition to an as-needed basis 312 in FIG. 3D. In another example, the system can update, for example, in addition to the update illustrated in FIG. 3D, one or more medication reminders, such as the medication reminders on the right in 428 in FIG. 4D. In some cases, the times, for example, the times listed for PROAIR™ HFA (albuterol sulfate) in FIG. 4D, can be set automatically depending on the required frequency of a medication. In some cases, administration of a third medication can be suggested, for example, in accordance with the action plan for the yellow zone. The user can check that administration of the third medication, for example, a long-term control medication per yellow zone settings is complete 1716. Next, the system can generate and display, manually or automatically, a medication update, for example, pop-up 1717.

As described in FIG. 17, upon zone determination, for example, steps 1706, 1710, or 1714, the system can determine that the zone is red. In this instance, as shown in FIG. 18, an indicator or alert, for example, pop-up alert can be displayed to inform the user of red zone 1801. Information or instructions can be displayed to the user, for example, in accordance with the action plan for the red zone. The information can be displayed at once to reduce or minimize user involvement in case of emergency 1806. The system can, for example, display quick-relief medication 1802, display other red zone medication 1803, show emergency number to dial 1804, allow the user to tap a number, for example, the displayed emergency number, and to automatically dial the emergency number 1805. The action plan can stop in 1807. The action plan can stop automatically, for example, after a given period of time, or manually, for example, prompted by the user. In some examples, one or more appropriate entities or individuals are notified by an alert system 1808. For example, the alert system can notify or alert individuals, for example, parents of an asthmatic patient, a healthcare provider such as the physician of the asthmatic patient, or an institution, such as school authorities of an asthmatic child. In some cases, the alert can be passive. For example, the alert can be passive and only display on the user's record. In some cases, the alert can be active, for example, via pager, phone call, mobile alert, SMS or email. The alert can actively notify one or more entities or individuals that the user is in the red zone.

Upon zone determination, for example, steps 1706, 1710, or 1714 in FIG. 17, the system can determine that the zone is green 1901. In this instance, as shown in FIG. 19, an indicator or alert, for example, pop-up alert, can be displayed to ask the user if the user wants to stop the action plan 1901. In 1902, if the user does want to stop the action plan, the system proceeds to stop the action plan in 1904. Alternatively, if the user does not want to stop the action plan, the system can, for example, return to the prior step, such as steps 1705, 1709, or 1713, and a prompt or pop-up inquiring how the user feels can be displayed automatically 1903.

An action plan, such as an interactive action plan, can be a vehicle for healthcare providers and patients to enter health-related information. The health-related information can include, for example, medical data, status, healthcare provider review or recommendations, medication, vendor information, and insurance information. In some examples, entering the health-related information using the action plan can be more facile than entering the health-related information without using the action plan.

In some implementations, the action plan facilitates use, for example, input, generation, and fulfillment, of a prescription. The action plan, for example, the interactive action plan, can be a vehicle for facilitating the use of a prescription. In some examples, inputting, generating, fulfilling, or otherwise managing the prescription using the action plan can be more facile than inputting, generating, fulfilling, or otherwise managing or implementing the prescription without using the action plan. In some implementations, at least a portion of the prescription management, implementation, and fulfillment can be monetized. In some examples, the monetization can include a fee or charge, for example, percentage of sales, fixed fee, and percentage of profit of a vendor. For example, the methods herein can include providing a periodic service, for example, monthly basis, to ship medication to users. The user can be charged for medications periodically, for example, on a monthly basis. The service can include a service fee or charge, as previously described. For example, a fraction of the value of the medication can be added as an additional fee to be paid by the user when using the service. The service fee or charge can be paid by, for example, a user, an affiliate partner, a vendor, and a medical product manufacturer. In some cases, one or more service fees or charges can be paid as part of a given transaction. For example, an entity can recommend the user to contact an affiliate party to perform a medical service such as a medical specialist service, special medication delivery service, insurance service, or a technical service, such as blood work or a physical evaluation. The user can be charged a first fee, for example, a fixed fee, while the affiliate party can be charged a second fee, for example, fee based on total value of referrals made.

The systems and methods for health management described herein can be provided, implemented, operated, controlled, and supervised by an entity. The entity can be an organization, for example, a partnership, a company, or a corporation, such as a for-profit or non-profit. The entity can comprise multiple private or public, for example, government, entities. The systems and methods herein can be used to provide various features or services, including, for example, action plans, prescription implementation and management, other medication services, recommendation and evaluation of medical care products, and recommendation, evaluation and mediation of various medical services provided by the entity or by affiliated entities or partners. Use of individual features or services can include a fee or charge collected by the entity. The systems and methods herein can include a user application or “app” for accessing various features or services. The features or services herein can be interactively provided or automatically suggested to users based on information related to the health condition of individual users maintained, accessed or otherwise transformed by the health management systems and methods herein.

In some examples, the systems and methods of the disclosure can include medical services, for example, mediation or referral to a specialist or technician. In some cases, at least a portion of the medical services can be implemented via a user application or “app.” The medical services can be fulfilled internally by the entity, for example, staff technician, or by an external party, such as an affiliate or a partnership. In some cases, different fees or charges can apply to internal and external services, for example, an internal service can be performed against a higher fee or charge than an external service or vice versa, a “rush” service can be performed against a higher fee or charge. For example, in the user application, a user can enter a trigger, and can be offered an option to select a relevant or follow-up service, for example, “click here to have your allergy tested”.

In some examples, the systems and methods of the disclosure can include medical product services or features, for example, mediation, recommendation, and evaluation of medical care products. For example, a suitable medical care product can be recommended to a user with a given symptom, trigger, or measurement value of a health-related parameter, for example, the system can suggest buying a peak flow meter to a user. In some cases, the medical care product can be produced, supplied, or distributed by the entity itself. Alternatively, the medical care product can be produced, supplied, or distributed by another entity, for example, an affiliated or partner entity. In some cases, at least a portion of the medical product services or features can be implemented via a user application or “app.”

In some examples, the systems and methods of the disclosure can include medication services or features, for example, prescription implementation, management, medication purchasing services, medication evaluation, and other medication services. In some cases, at least a portion of the medical services or features can be implemented via a user application or “app.” A user can be prompted or offered on the user application an option to select whether the user would like to have medication shipped, for example, “click here to have your allergy tested”.

In some implementations, medical services, medical care products, medication, and other features or services can be provided to a user, for example, patients, consumers, and healthcare providers. For example, a medical care product, such as a peak flow meter, can be sold by the entity maintaining the health management system to healthcare providers, or directly to consumers, such as patients. In some cases, the medical care product can be sold by an affiliate or a partner entity on behalf of the entity, for example, using a licensed brand of the entity. In some cases, the medical care product can be sold by an affiliate or a partner entity independently of the entity. The affiliate or partner entity may or may not involve the entity when selling the medical care product. In some examples, the affiliate or partner entity can recommend the health management systems, features, or services provided by the entity to a consumer or patient. For example, a peak flow meter purchased by a user can be provided with a note or recommendation, for example, a link for downloading the application, to track the user's health condition, for example, asthma, using the health management system of the disclosure. When a partnership structure exists, services, for example, medical services, medical care products, and medications can flow back and forth in both directions between various entities depending on the situation. Health management features and services can be provided in accordance with symptoms, measurements, and various pieces of information provided, for example, to the system for health management by the user, the patient, the healthcare provider, and other entities interacting with the system, for example, third party services. For example, different services, features, or products can be activated when insurance or pricing information is received by the system. In another example, different services, features, or products can be activated upon user input, for example, current physiological condition of the user, triggers, medical history, and allergies to medication.

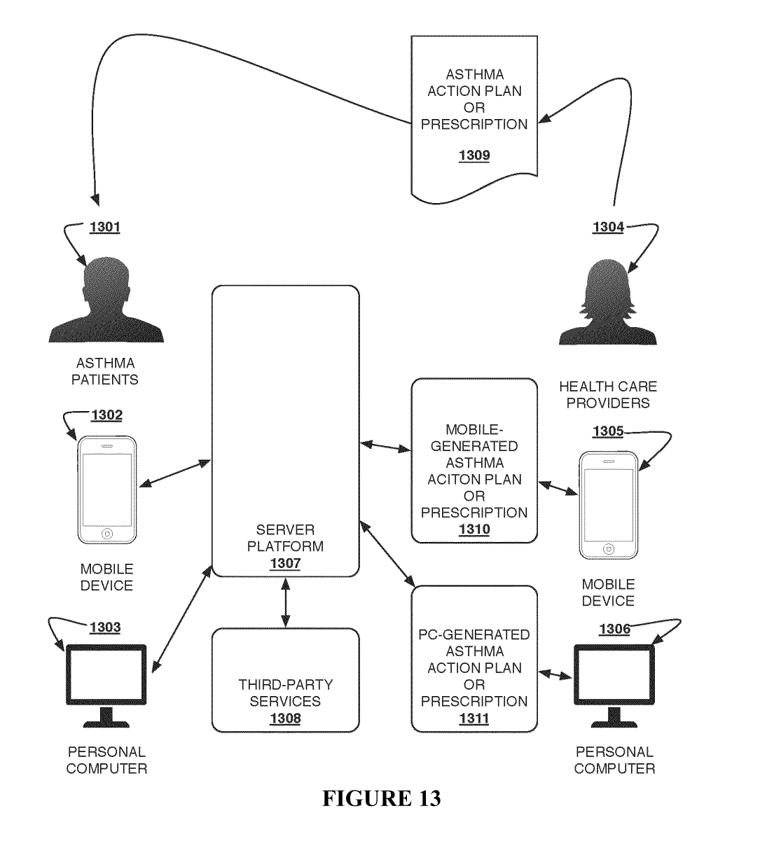

FIG. 13 is an example of a health management system interacting with various entities. The interactions can in some cases include features or services. The system can comprise a computer server platform 1307, which can be similar to computer server platform 207 in FIG. 2. The server platform can be configured to interact over a communications network with one or more entities, including, for example third party services 1308, which can be similar to third party services 107 in FIG. 1; healthcare providers 1304, similar to healthcare providers 204; patients 1301, similar to patients 201; and other entities or systems. One or more entities, for example, the patients 1301 can interact with the platform using user applications. The patients 1301 and the healthcare providers 1304 can interact with the health management platform 1307 via mobile devices 1302 and 1305, which can be similar to 202 and 205, respectively, via personal computers 1303 and 1306, which can be similar to 203 and 206, respectively, or both. In this example, the healthcare provider can provide an asthma action plan or prescription 1309 to asthma patients 1301 with the aid of the health management system. In some implementations, the action plan or prescription can be a mobile-generated action plan or prescription 1310. The mobile-generated action plan or prescription can be generated through interaction with the healthcare provider 1304 using the mobile device 1305. In some implementations, the action plan or prescription can be a PC-generated action plan or prescription 1311. The PC-generated action plan or prescription can be generated through interaction with the healthcare provider 1304 using the computer 1306 of the healthcare provider. The generation of the action plans 1310 and 1311 can include information provided to and from the system through interaction with other entities or systems, and information processed, or generated within the system. The generation of the prescription 1310 and 1311 can include information provided to and from the system through interaction with other entities or systems, and information processed or generated within the system.

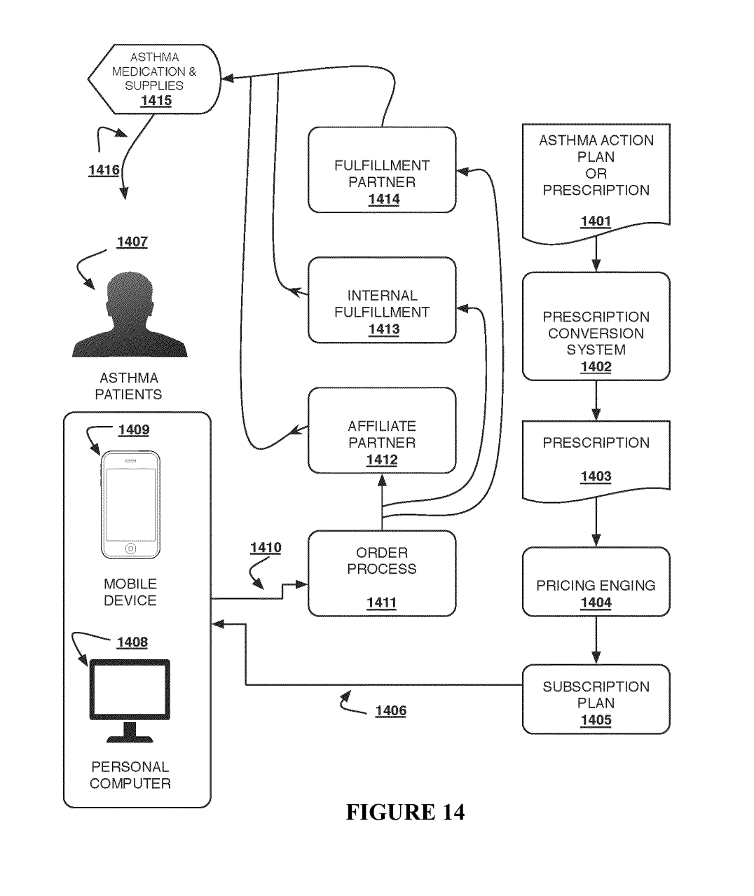

FIG. 14 is an example of features and services provided to a user 1407, for example, asthma patient 1301 of a health management system. The services can be provided to the user at a mobile device 1409, similar to mobile device 1302, or a computer 1408, similar to computer 1303. In this example, asthma medication and supplies 1415 are provided to the user at 1416. At 1410, the user can initiate an order process 1411. As a result of the order process, additional processing, for example, order fulfillment, can be performed by an affiliate partner 1412, through internal fulfillment 1413, or through a fulfillment partner 1414. In some examples, a fulfillment partner can be a distributor or wholesaler associated with the health management system. The fulfillment partner can be given instructions to complete an order generated and processed by the system. In some examples, internal fulfillment can include fulfillment by the entity operating the health management system. In some examples, one or more processing steps implemented by the system in the case of the fulfillment partner 1414 can be performed by the affiliate partner or outsourced. The affiliate partner can perform the services performed by the fulfillment partner. Further, in some cases, the entities 1412, 1413 and 1414 can interact with each other. For example, the affiliate partner 1412 can refer a portion of the processing to the fulfillment partner 1414. In some cases, the entities 1412, 1413 and 1414 can process and fulfill the order independently. The processing and fulfillment performed by the entities 1412, 1413 and 1414 can result in the delivery 1416 or order of medication and supplies 1415.

A subscription plan 1405, for example, for a medication, can be provided to the user at 1406. An action plan or prescription 1401, for example, similar to action plan or prescription 1309 can be processed in a prescription conversion system 1402 to generate a prescription 1403. The prescription 1403 can be processed using a pricing engine 1404, for example, using the methods described herein, such as the method in FIG. 11C. In some cases, the subscription plan 1405 can be generated based on the action plan or prescription. In some cases, the subscription plan may not be generated, or can be bypassed.

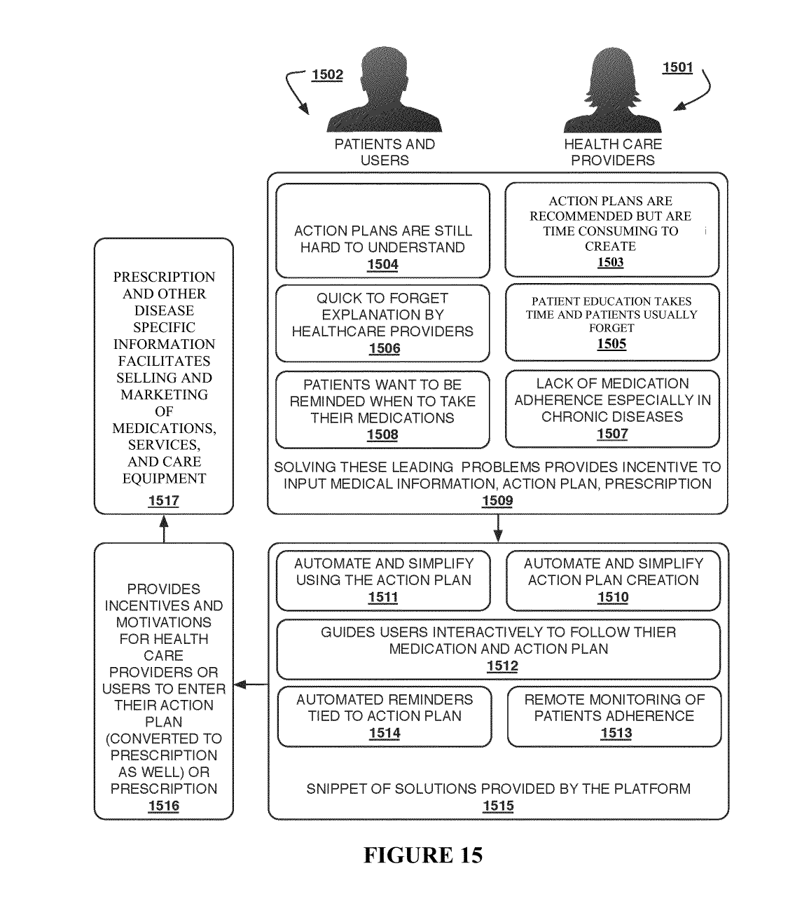

FIG. 15 schematically illustrates benefits of systems and methods for health management in accordance with the present disclosure. Patients and users 1502, similar to patients 1301, can experience, for example, problems 1504, 1506 and 1508. Action plans can be hard to understand 1504. Patients and users can forget explanations given by healthcare providers 1506 in relation to, for example, medication procedures. Patients and users often want to be reminded when to take medications 1508. Healthcare providers 1501, similar to healthcare providers 1304, can experience, for example, problems 1503, 1505 and 1507. For example, the healthcare providers can find that an action plan is recommended but is time-consuming to create 1503. Further, the healthcare providers can find that patient education takes time and that patients frequently forget 1505. In some cases, healthcare providers can find a lack of medication adherence 1507, for example, in chronic diseases. Solving at least a portion or all of these problems can provide or be an incentive to input, for example, medical information, action plans, and prescriptions using the systems and methods herein 1509. Solutions to these problems can include features provided by systems and methods herein 1515, similar to platform 1307. In some examples, the solutions can include, for example, automating and simplifying use of the action plan 1511, automating and simplifying action plan creation 1510, interactively guiding users to follow their medication and action plans 1512, providing automated reminders tied to the action plan 1514, and remotely monitoring patients' adherence 1513. In some examples, the solutions 1515 can provide incentives and motivations for healthcare providers and users to enter the action plan, such as the user's action plan, or the action plan converted to a prescription, or the prescription 1516. The entered prescription and other disease-specific information can be used by, for example, the health management system provider, partner, affiliate or other entity associated with the health management system to facilitate selling and marketing of medications, services and care equipment 1517, which can include, medical services, medical care product, medical care product services, medication, and medication services.

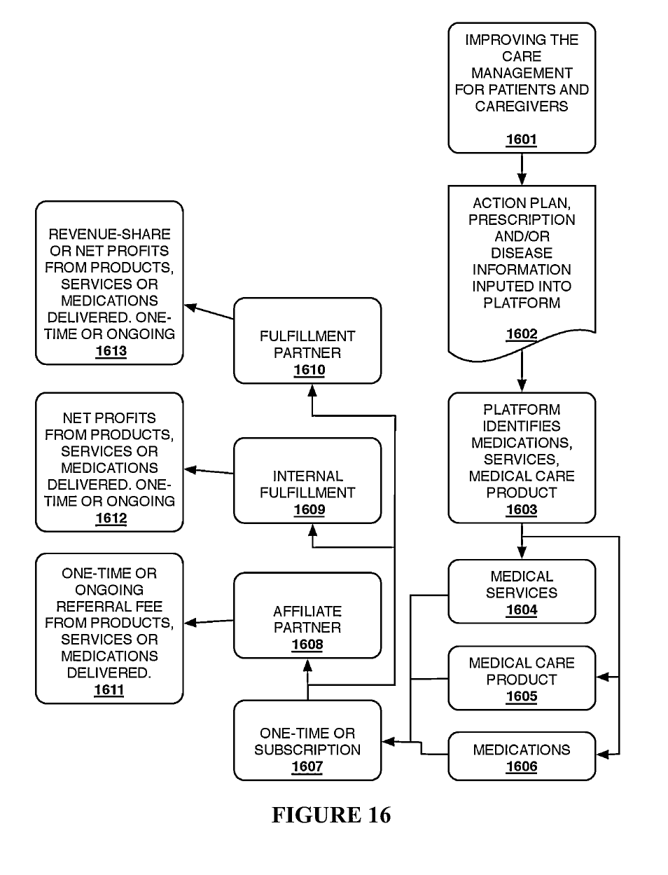

FIG. 16 schematically illustrates revenue streams associated with health management services in accordance with the present disclosure. The systems and methods herein can be used for improving care management for patients and caregivers 1601. One or more inputs can be provided to the health management platform 1602, such as, for example, an action plan, a prescription, health condition, disease information, triggers, physiological measurements, and symptoms. The health management platform can, for example, identify medications, services, and medical care products 1603. In some cases, one or more medical services 1604, medical care products 1605, and medications 1606 are identified. The identified services, products, and medications can be used to generate a one-time order or a subscription order 1607. The order 1607 can be processed and fulfilled by an affiliate partner 1608, through internal fulfillment 1609, by a fulfillment partner 1610, or a combination thereof. For example, a multi-part or complex order can be fulfilled or processed in parallel by multiple entities. The fulfillment partner 1610 can, for example, participate in revenue-share with the health management platform provider, or obtain net profits from products, services or mediations delivered on one-time or ongoing basis 1613. The internal fulfillment 1609 can, for example, result in net profits from products, services, or mediations delivered on one-time or ongoing basis 1612. The affiliate partner 1608 can, for example, obtain a one-time or ongoing referral fee from products, services, or mediations delivered 1611.

### EXAMPLES

### Example 1

### Use of the Health Management Platform for Managing Medications

FIG. 3A is a screenshot of a graphical user interface (GUI) 300 of user “Kubilay” showing a list of quick-relief medications 301 and long-term control medications 302. In this example, the medications 301 include albuterol, and the medications 302 include DUONEB™ (Ipratropium bromide and albuterol) and FLOVENT™ (fluticasone). In some implementations, the list of medications can be used by the user to track use of prescribed or recommended medications during a given time period, for example, a day. The user can select one or more check boxes after taking the medication. In some cases, a single box 303 is provided for a medication, for example, albuterol taken as needed, or for a medication consumed in a dose or quantity of, for example, 1 puff per day, for example, FLOVENT™ (fluticasone). In some cases, a plurality of boxes 304 are provided. For example, 6 boxes are provided for a medication taken in a dose or quantity of, for example, 2 puffs every 4 hours, such as DUONEB™ (Ipratropium bromide and albuterol). The selection of the boxes 303 and 304 can provide an input to a health management system that medication is taken by the user, for example, a patient, as planned, in accordance with an action plan zone. For example, in the screenshot on the right in FIG. 3A, the user has entered that albuterol was taken as needed by the user. In some cases, the user can activate, for example, using a click or tap a button 305, to enter the data or information provided by selecting one or more boxes. In some cases, the user can activate a button 306 to cancel the data entry, such as time entry of medications. In some implementations, a medication list with a selection box can alternatively be used, for example, to add a medication to an action plan, to order the medication, and to renew a prescription for the medication.

FIG. 3B are screenshots of the GUI 300, where the user has entered two instances of taking DUONEB™ (ipratropium bromide and albuterol) on the left, and a full daily dose, for example, five instances, on the right. In some cases, the health management system can automatically add a time stamp to user entries in order to keep track of intervals between doses. For example, a first dose can be entered at a first point in time and a second dose, for example, as shown in FIG. 3B, can be entered at a second point in time. In some cases, the GUI can allow the user to enter their daily medication at once. For example, as shown, DUONEB™ (ipratropium bromide and albuterol) 304 is required to be taken every 4 hours. If the user does not want to use the app every 4 hours, the user can tap a control 314 (FIG. 3A), for example, the last circle or box, and the interface can automatically check all the prior circles, or boxes, controls, or other interactive features, enabling the user to check their daily medication intake with one tap instead of tapping all the individual circles 304. In some implementations, when the system is configured to remind the user only once in a given time period, for example, the user has set the reminders to only be reminded one time per day, the system can automate the medication entry page for one tap entry only.

FIG. 3C is another screenshot of the GUI 300, in which two options are provided for albuterol. In a first scenario, albuterol can be taken as needed, and the box 303 can be checked by the user each time the medication is taken. In this case, the box 303 can be checked by the user. In a second scenario, albuterol can be taken on a scheduled basis in multiple doses at given time intervals, for example, 2 puffs every 4 hours. In this case, multiple boxes 304 can be checked by the user. On the left of FIG. 3C, no boxes are checked. On the right, two doses of albuterol are checked. In some cases, multiple doses can be entered at the same time, for example, as shown for albuterol. In some cases, previously entered doses can be marked by an indicator 315, for example, a black background, as shown for DUONEB™ (Ipratropium bromide and albuterol).

FIG. 3D is a screenshot showing the two configurations of the GUI 300 shown on the left in FIG. 3A and FIG. 3C, respectively. In some implementations, the system can change, automatically or manually, the medication, dosage, or both. In some cases, the change can be based on a preset schedule, such as, if the user is required to take a given medication on a given basis, for example, daily basis, for a given period of time, for example, two weeks. When the time period passes, the system and the GUI can change such that the medication is no longer displayed. In some cases, the change in configuration of the GUI 300 can be a result of the outcome of an action plan. For example, if the user activates the action plan, and the system identifies in the process that the user needs to be on schedule for a yellow zone medication, the GUI can change, for example, from configuration 312 to configuration 313.

In some cases, medication entry lists can include additional or fewer medications than shown in FIG. 3D. In some cases, 1, 2, 3, 4, 5, 10, or more schedules or options can be provided for each medication. The user can select a schedule or option for each medication from a drop-down list. In some implementations, the lists in FIGS. 3A-3D can be automatically populated by the health management system, for example, based on a prescription or an action plan. In some implementations, one or more medications can be added by the user. In some implementations, medications can be selected by a user, for example, as shown in FIGS. 4A-4D.

The GUIs in FIGS. 3A-3D can have a menu or navigation bar 310. In some cases, the bar can have a permanent configuration, for example, the same configuration for different GUIs. Alternatively, the configuration of the bar can change as the user navigates between menus. Further, in some configurations, a default bar, for example, a “home” bar can be implemented by activating one or more controls, such as, a “master” or “home” button. The menu or bar can provide links to GUIs for performing various tasks. In this example, the bar 310 comprises an “enter data” control 308, for example, for displaying a data entry interface, a “diary chart” control 309, for example, for displaying a log of user activity and health events, a “chart” control 310, for example, for displaying medical statistics and trends related to the user's health condition, and a “settings” control 311, for example, for adjusting user settings.

### Example 2

### Health Management System Customized by the User

FIGS. 4A-4C show screenshots of GUIs of a health management system in which a user can select specific medications, doses, and frequency for individual action plan zones. In this example, in the screenshot on the left of GUI 400, the user can select between albuterol-based quick-relief medications VENTOLIN™ HFA (albuterol sulfate), ACCUNEB™ (albuterol sulfate), PROVENTIL™ HFA (albuterol sulfate), or PROAIR™ HFA (albuterol sulfate) by selecting option 423, 424, 425, or 426, respectively. The user can select to abort the selection and go back to an earlier screen by activating control 405. Alternatively, the user can select to go to a subsequent GUI interface 401, shown in the screenshot on the right, by activating control 406. From the interface 401, the user can select between budesonide-type long-term control medications PULMICORT FLEXHALER™ (budesonide) and PLUMICORT RESPULES™ (budesonide). Again, the user can select to abort the selection and go back to an earlier screen or to advance to a subsequent screen or GUI 402, shown on the left in FIG. 4B. The interface 402 can allow the user to select parameters for medications associated with a first, for example, green zone, of an action plan.

In the example in FIG. 4B, on the left, the user can have previously selected, for example, through the GUIs 400 and 401, VENTOLIN™ HFA (albuterol sulfate) as the quick-relief medication, and PULMICORT FLEXHALER™ (budesonide) as the long-term control medication. Using the GUI 402, the user can select the strength of the selected medication, for example, concentration of an active substance, dose of the selected medication, and frequency of administration of the selected medication. In this example, the user selects 100 milligram (mg) of VENTOLIN™ HFA (albuterol sulfate), instead of 150 mg, in 1 liquid dose, instead of 2 liquid doses, and administered once a day, instead of twice a day. The user also selects 100 mg of PULMICORT FLEXHALER™ (budesonide), instead of 150 mg, in 1 liquid dose, instead of 2 liquid doses, and administered once a day, instead of twice a day. On the right, a bottom portion of the interface 402 is shown, where the user is given an option 407 to add new medication, for example, not previously selected via the interfaces 400 or 401. The zone for which settings are selected can be highlighted, for example, in a status bar 408, as shown in a highlighted “green zone” portion 415 of the status bar.

In FIG. 4C, on the left, settings or parameters for medications associated with a second, for example, yellow, zone of the action plan are selected in GUI 403. In this example, the user selects the same medications and parameters for the second zone as for the first zone. A “yellow zone” portion 416 of the status bar is highlighted. In FIG. 4C, on the right, settings or parameters for medications associated with a third, for example, red zone of the action plan, are selected in GUI 404. In this example, the user again selects the same medications and parameters for the third zone as for the first and second zones. A “red zone” portion 417 of the status bar is highlighted.

In FIG. 4D, in interface 427 on the left, the user can enter information, including, for example, the user's phone number and a healthcare provider's phone number. In some cases, the user can certify, for example, by selecting control 418, that the action plan, for example, the action plan selected in FIGS. 4A-4C, was issued by a healthcare provider. A keyboard 419 can be provided to facilitate numerical input. On the right, an interface 428 showing scheduled medication for the user, for example, user “Vicki”, is presented. In some cases, the user can be alerted regarding scheduled medication through individual reminders. In some implementations, the reminders can be turned on or off. When turned on, the reminder can indicate whether the medication is to be taken once a day or as prescribed. Further the reminder can indicate when, for example, times doses of the medication are to be administered. For example, a reminder 420 for taking ACCUNEB™ (albuterol sulfate) can be selected or toggled, reminding the user to take ACCUNEB™ (albuterol sulfate) as prescribed. A reminder 421 for PROAIR™ HFA (albuterol sulfate) can also be selected or toggled, reminding the user to take PROAIR™ HFA (albuterol sulfate) as prescribed and listing specific times for administering the medication, for example, a reminder or alarm can be provided for each of the times. Further, a reminder for taking PULMICORT FLEXHALER™ (budesonide) can be selected or toggled, reminding the user to take PULMICORT FLEXHALER™ (budesonide) as prescribed.

The GUIs in FIGS. 4A-4D can have a menu or navigation bar 409. The menu or bar can provide links to GUIs for performing various tasks. In FIG. 4B, the bar 409 comprises an “enter data” control 410, for example, for displaying a data entry interface; a “diary chart” control 411, for example, for displaying a log of user activity and health events; a “reminders” control 412, for example, an interface for setting alarm to take or order a medication; an “action plan” control 413, for example, for displaying an action plan interface or status; and a “settings” control 414, for example, for adjusting user settings. In some cases, the bar can have a permanent configuration, for example, the same configuration for different GUIs. Alternatively, the configuration of the bar can change as the user navigates between menus.

### Example 3

### Use of the Health Management System to Manage a Health Condition, for Example, Asthma

FIG. 5A shows screenshots of a user interface 500 with instructions associated with an action plan zone and a user interface 501 for entering peak expiratory flow and symptoms. The interface 500 can be an automated and interactive embodiment of an action plan. In some implementations, other interfaces, for example, interface 516 in FIG. 5D, can be less interactive or less automated interfaces of the same action plan. In some implementations, the user can switch between interfaces, for example, interfaces 500 and 516, by changing the orientation of a user device, for example, mobile device. For example, the user can change the orientation of the user device from a vertical to a horizontal position. In some cases, the interface 500 can be generated based on data entered using one or more other interfaces. For example, the interface 500 can be generated based on data entered in the interfaces 400, 401, 402, 403, and 427. In some cases, the interface 500 can be generated based on data entered by a healthcare provider, for example, via mobile or a web portal, or entered by a user, for example, via web portal. In some cases, the system can only need the medications used and can create, automatically or manually, the interface 500 based on best medical practices of the medications entered. In some cases the interface 501 can be activated by interface 500. Conversely, the interface 501 can be used to set peak expiratory flow and symptoms associated with the interface 500. For example, an action plan for a yellow zone can comprise the steps of ascertaining a health condition of the user, for example, “how are you?” 506, administering a first dose using a previously determined medication and dose, for example, 1 puff of VENTOLIN™ HFA (albuterol sulfate) 507, waiting a given time period, for example, 60 minutes 508, again ascertaining a health condition of the user 509, administering a second previously determined medication and dose, for example, 1 puff of PULMICORT FLEXHALER™ (budesonide) 510, and taking medications as needed 511. The action plan can include a progress bar 512 and a status bar 504 indicating the identity of the zone, for example, “yellow” zone 505. The steps 506 and 509 can include providing information to the health management system, for example, independent of zone, via the interface 501. Peak expiratory flow and symptoms can be entered, for example, listed or selected via the interface 501. In some cases, the peak expiratory flow and symptoms controls can be selected and an interface with detailed questions can be displayed.

FIG. 5B shows, on the left, screenshots of a user interface 502, for example, similar to the interface 500 with the exception of administering VENTOLIN™ HFA (albuterol sulfate) instead of PULMICORT FLEXHALER™ (budesonide) in step 510, during implementation of action items associated with an action plan zone, for example, the zone 505. In this case, the progress bar 512 is activated and shows steps, for example, which steps are completed, which steps are in progress, and which steps remain. For example, the action plan shown in the interface 502 shows that the action plan started, the steps 506 and 507 are completed, and the step 508 is in progress with 28 minutes of the 30 minutes remaining. Further, information in the action plan can be updated based on progress of the action plan. In some cases, the user can jump one or more steps in, or along, the progress bar. For example if the user has already taken VENTOLIN™ HFA (albuterol sulfate) and has waited 30 minutes, the user can jump to 509 by tapping on the action item without the need of stepping through 506, 507, and 508.

Interface 503 of user “Vicki” is another example, similar to interfaces shown in FIGS. 3A-3D, of a graphical user interface for inputting administered medications. In some cases, the action plan can be linked or otherwise dependent on or connected to one or more medication schedules. For example, as the action plan steps progress in the interface 502, the system can require the user Vicki to take VENTOLIN™ HFA (albuterol sulfate), and the medication interface 503 can be updated, for example, automatically, to show VENTOLIN™ HFA (albuterol sulfate) in the list of medications for user Vicki. In some implementations, the interface 503 is displayed when a given action plan zone is implemented. In some cases, only medication associated with the implemented zone is displayed. In other cases, all medication is displayed and the user can enter the medication taken in accordance with instructions associated with the implemented one. In this example, the user can enter usage of quick-relief medications ACCUNEB™ (albuterol sulfate), if taken as needed; PROAIR™ HFA (albuterol sulfate), taken as needed, or if on schedule, 1 inhalation every 4 hours; and VENTOLIN™ HFA (albuterol sulfate), taken as needed, or if on schedule, 1 inhalation every day. In this case, three check boxes 513 for PROAIR™ HFA (albuterol sulfate) are provided over a time period of 12 hours. In some examples, the time entry of administered medication can be performed over a given total time period. In some cases, the total time period can be decreased, such as, for example, in accordance with the severity of the user's health condition. Further, the user can enter usage of control medications.

As previously described, the GUIs of the disclosure can have a menu or navigation bar 514. In this example, the “enter data” control of the bar 514 is activated while the data entry interface 503 is displayed.

FIG. 5C is an example of an action plan, for example, an asthma action plan, divided into three zones, for example, green, yellow, and red. The action plan can include, for example, patient name, medical record number, date of birth, healthcare provider's name, healthcare provider's phone number, identity of person completing the action plan, and date. The action plan can also include, for example, a list of long-term medications, how much to take of each long-term medication, how often, how many times every day, and other instructions regarding long-term medications. Further, the action plan can include, for example, a list of quick-relief medications, how much to take of each quick-relief medication, how often, for example, take only as needed, and other instructions, such as, if a quick-relief medication is needed frequently, call healthcare provider to consider increasing long-term-control medications.

The action plan can include a scale or measure of peak expiratory flow, for example, from a graphical peak flow meter or other spirometry devices. The scale can include a “personal best” peak expiratory flow, as well as one or more reference points for peak expiratory flow versus the personal best peak expiratory flow, for example, 80% personal best peak expiratory flow, 50% personal best peak expiratory flow, and under.

The green zone can represent a health condition of the user on a daily basis. In this zone, the user can be free of asthma symptoms and feel “good”. To maintain this health condition, the user can continue to take long-term control medications even if the user is feeling well. The green zone can include instructions, for example, to take long-term-control medications listed in the action plan every day, to take a given amount of puffs of a medication before exercise, and to avoid a list of factors that make the health condition worse.

For health conditions corresponding to the yellow zone, the user can experience symptoms and feel “not good”. In this zone, the user can slow down and follow steps, for example, steps of the action plan, including, for example, use of quick-relief medication to keep the asthma from getting worse. The yellow zone can include a list of symptoms, for example, wheeze, tight chest, cough, shortness of breath, waking up at night with symptoms, and decreased ability to do usual activities. The yellow zone can also include instructions, for example, to continue taking long-term-control medications every day, to take a given medication and, if still not feeling good or when peak expiratory flow is not back in the green zone within an hour, to increase or add a given medication or medications, and to call one or more listed contacts.

The red zone corresponds to severe asthma symptoms or an asthma flare-up, for example, the user can feel “awful”. For such health conditions, the user can follow the steps of the action plan and get immediate medical treatment if the symptoms do not improve. The red zone can include a list of symptoms, for example, getting harder and harder to breathe, and unable to sleep or do usual activities due to trouble breathing. The red zone can also include instructions, for example, to get help, to take a given medication until immediate help is received, to take a given medication or medications, and to call one or more listed contacts.

Generation of the action plan can be time-consuming for the user and the healthcare provider. The present disclosure provides systems and methods for partially or fully generating the action plan, for example, automatically, or in combination with manual implementation by the user, the healthcare provider, user's guardian, or any combination thereof. Further, the action plan can be difficult to adjust based on changes in the user's health condition, or other factors, for example, available drugs, and regulatory changes.

FIG. 5D shows example screenshots of action plans 515 and 516 generated using the systems and methods of the disclosure. The action plan in FIG. 5D can be designed to be familiar to users accustomed or used to a traditional action plan, for example, the action plan in FIG. 5C. In some cases, for example, when the user is using a mobile device, the user can alternate between various interfaces. For example, the user can alternate to an interactive mode, for example, interfaces 500 and 502, by changing the orientation of the mobile device from horizontal, for example, interface 515 and 516, to vertical orientation, for example, interface 500 and 502. Each action plan can have a summary section 517 and an instruction section 518. In some cases, at least a portion of the summary section and the instruction section can be partially hidden or overlaid. For example, the summary section can be expanded or displayed when activated.

The action plan 515 can represent, for example, a green zone. The summary section can list a summary of the user's health condition, including, for example, that no cough, wheeze, chest tightness, or shortness of breath during the day or night are experienced by the user, and that the user can do usual activities. The summary section can also show a current or benchmark peak expiratory flow value of the user, for example, 720 or more. In some cases, the system can generate, for example, automatically, peak expiratory flow value thresholds or thresholds for other spirometry measurements, such as forced expiratory volume in 1 second. In some cases, the system can generate the peak expiratory flow value thresholds by looking at historical peak expiratory flow values entered by the user and selecting a value, for example, highest value, as the user's personal best value. In some cases, the system does not have enough historical data, or the user does not want the system to use the historical data to make threshold calculations. In such cases, the system can use an algorithm to calculate the peak expiratory flow value thresholds. In some implementations, the algorithm can use age, height, and gender. In some implementations, the algorithm can use age, height, gender, and sex. In some implementations, the algorithm can also consider weight. In some implementations, the algorithm can use age, height, gender, sex, weight, or any combination thereof. The instruction section can include, for example, instructions to take control medications every day, to take a medication, for example, under given circumstances, take a puff of FLOVENT™ (fluticasone), and to avoid factors that make the health condition, for example, asthma, worse. In some cases, the instruction section can additionally highlight which medications have not been taken yet as recommended. For example, red underline text “Take 2 puffs of FLOVENT™ (fluticasone) now” can be displayed and the user can tap on the item to verify and record taking the medications.

The action plan 516 can represent, for example, a yellow zone. The summary section is not expanded in this example. The instruction section can include instructions to continue taking every day long-term control medications every day. The instruction section can include instructions to take a given quick relief medication, for example, take 2 puffs of quick relief medication. The instruction section can also include instructions to take additional medication, for example, 2 more puffs of the previously administered quick relief medication, if not back in the green zone within about 20 to about 30 minutes. Further, if not back in the green zone within one hour, the instructions can include, for example, taking one or more additional medications, for example, 3 puffs of FLOVENT™ (fluticasone), 2 pills of ADVAIR DISKUS 100/50™ (fluticasone propionate and salmeterol), or both; calling a health provider or an emergency number; and continuing to use quick relief medication, for example, every 4 hours as needed; and calling the health provider if the condition is not improving, for example, in 2 days.

### Example 4

### Display Functionality of a User Display Device of the Health Management System

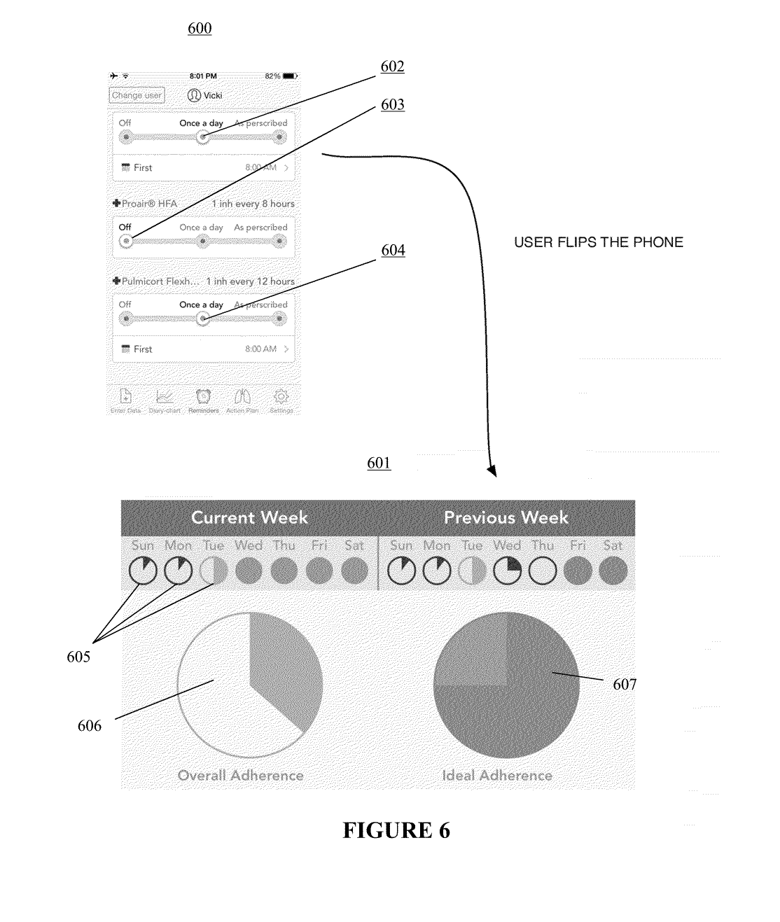

FIG. 6 is an example of display functionality on a user display device. In this example, a reminder interface can be presented in two display modes 600 and 601. The display modes can provide interfaces that are similar, for example, zoomed in, or interfaces that are dissimilar. In some cases, the display modes can show related interfaces, for example, interfaces displaying related information. In the first mode 600, the interface can display, for example, similarly to the interface 428, scheduled medications for a user, for example, user “Vicki”. The medication reminders can include a reminder 602 for a first medication to be taken once a day, a reminder 603 for PROAIR™ HFA (albuterol sulfate) that is turned off, and a reminder 604 for PULMICORT FLEXHALER™ (budesonide) to be taken once a day. When the user flips the display device, for example, rotates a phone 45 degrees, the second mode interface 601 can be displayed. In some instances, the interface 601 can show adherence of the user to reminders and action items over a given time period. The interface 601 can display adherence on individual days 605, for example, individual days during a period of two weeks, and overall adherence 606 during a given time period, for example, during a period of two weeks. The overall adherence 605 can be an average or weighted function of the individual adherences 606. The adherences can be graphically represented, for example, as pie charts. The adherence can be represented as a percentage of ideal adherence 607, for example, filling a portion of the pie chart corresponding to the percentage. Further, the degree of adherence can be classified or highlighted, for example, green if excellent adherence, yellow if acceptable adherence, and red if not acceptable adherence. In some instances, adherence may not be recorded. In some implementations, the adherence display can compare adherence with total population, with regional population, with population within a medical facility or population connected by age, gender, or healthcare provider.

### Example 13

### Computer Architectures

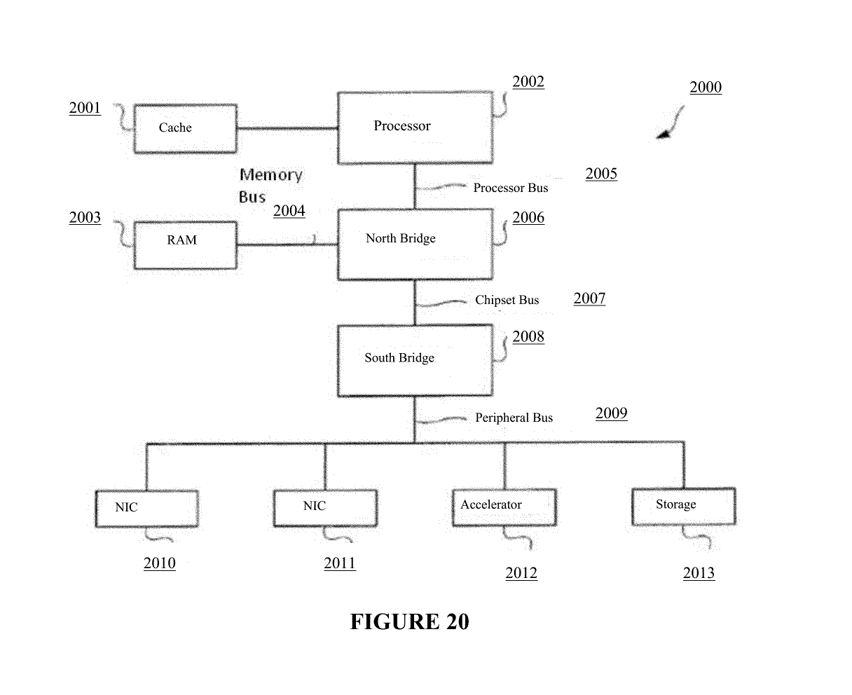

Various computer architectures are suitable for use with the invention. FIG. 20 is a block diagram illustrating a first example architecture of a computer system 2000 that can be used in connection with example embodiments of the present invention. As depicted in FIG. 20, the example computer system can include a processor 2002 for processing instructions. Non-limiting examples of processors include: Intel Core 17™ processor, Intel Core i5™ processor, Intel Core i3™ processor, Intel Xeon™ processor, AMD Opteron™ processor, Samsung 32-bit RISC ARM 1176JZ(F)-S v1.0 ARM Cortex-A8 Samsung S5PC100™ processor, ARM Cortex-A8 Apple A4 Marvell PXA 930™ processor, or a functionally-equivalent processor. Multiple threads of execution can be used for parallel processing. In some embodiments, multiple processors or processors with multiple cores can be used, whether in a single computer system, in a cluster, or distributed across systems over a network comprising a plurality of computers, cell phones, and/or personal data assistant devices.

### Data Acquisition, Processing and Storage.

As illustrated in FIG. 20, a high speed cache 2001 can be connected to, or incorporated in, the processor 2002 to provide a high speed memory for instructions or data that have been recently, or are frequently, used by processor 2002. The processor 2002 is connected to a north bridge 2006 by a processor bus 2005. The north bridge 2006 is connected to random access memory (RAM) 2003 by a memory bus 2004 and manages access to the RAM 2003 by the processor 2002. The north bridge 2006 is also connected to a south bridge 2008 by a chipset bus 2007. The south bridge 2008 is, in turn, connected to a peripheral bus 2009. The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus 2009. In some architectures, the functionality of the north bridge can be incorporated into the processor instead of using a separate north bridge chip.

In some embodiments, system 2000 can include an accelerator card 2012 attached to the peripheral bus 2009. The accelerator can include field programmable gate arrays (FPGAs) or other hardware for accelerating certain processing.

### Software Interface(s).

Software and data are stored in external storage 2013 and can be loaded into RAM 2003 and/or cache 2001 for use by the processor. The system 2000 includes an operating system for managing system resources; non-limiting examples of operating systems include: Linux, Windows™, MACOS™, BlackBerry OS™, iOS™, and other functionally-equivalent operating systems, as well as application software running on top of the operating system.

In this example, system 2000 also includes network interface cards (NICs) 2010 and 2011 connected to the peripheral bus for providing network interfaces to external storage, such as Network Attached Storage (NAS) and other computer systems that can be used for distributed parallel processing.

### Computer Systems.

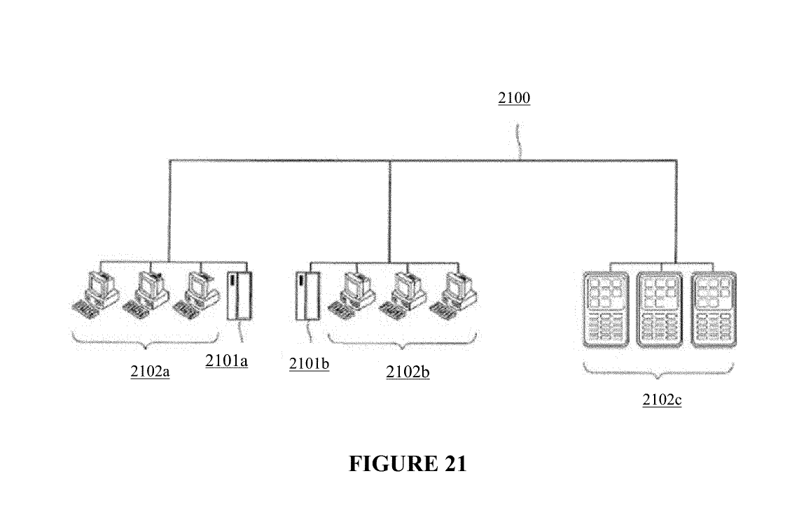

FIG. 21 is a diagram showing a network 2100 with a plurality of computer systems 2102a, and 2102b, a plurality of cell phones and personal data assistants 2102c, and Network Attached Storage (NAS) 2101a, and 2101b. In some embodiments, systems 2102a, 2102b, and 2102c can manage data storage and optimize data access for data stored in Network Attached Storage (NAS) 2101a and 2102b. A mathematical model can be used for the data and be evaluated using distributed parallel processing across computer systems 2102a, and 2102b, and cell phone and personal data assistant systems 2102c. Computer systems 2102a, and 2102b, and cell phone and personal data assistant systems 2102c can also provide parallel processing for adaptive data restructuring of the data stored in Network Attached Storage (NAS) 2101a and 2101b. FIG. 21 illustrates an example only, and a wide variety of other computer architectures and systems can be used in conjunction with the various embodiments of the present invention. For example, a blade server can be used to provide parallel processing. Processor blades can be connected through a back plane to provide parallel processing. Storage can also be connected to the back plane or as Network Attached Storage (NAS) through a separate network interface.

In some embodiments, processors can maintain separate memory spaces and transmit data through network interfaces, back plane, or other connectors for parallel processing by other processors. In some embodiments, some or all of the processors can use a shared virtual address memory space.

### Virtual Systems.

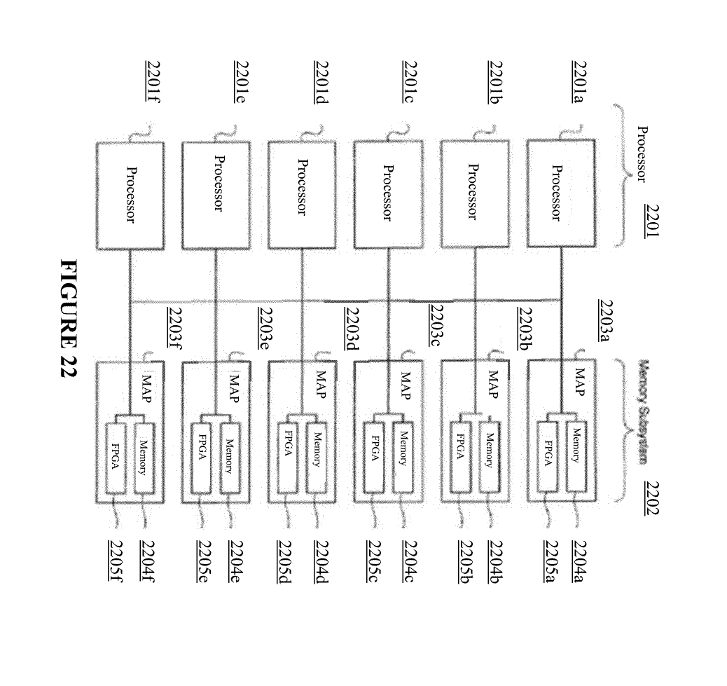

FIG. 22 is a block diagram of a multiprocessor computer system using a shared virtual address memory space. The system includes a plurality of processors 2201a-f that can access a shared memory subsystem 2202. The system incorporates a plurality of programmable hardware memory algorithm processors (MAPs) 2203a-f in the memory subsystem 2202. Each MAP 2203a-f can comprise a memory 2204a-f and one or more field programmable gate arrays (FPGAs) 2205a-f. The MAP provides a configurable functional unit and particular algorithms or portions of algorithms can be provided to the FPGAs 2205a-f for processing in close coordination with a respective processor. In this example, each MAP is globally accessible by all of the processors for these purposes. In one configuration, each MAP can use Direct Memory Access (DMA) to access an associated memory 2204a-f, allowing it to execute tasks independently of, and asynchronously from, the respective microprocessor 2201a-f. In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example embodiments, including systems using any combination of general processors, co-processors, FPGAs and other programmable logic devices, system on chips (SOCs), application specific integrated circuits (ASICs), and other processing and logic elements. Any variety of data storage media can be used in connection with example embodiments, including random access memory, hard drives, flash memory, tape drives, disk arrays, Network Attached Storage (NAS) and other local or distributed data storage devices and systems.

In example embodiments, the computer system can be implemented using software modules executing on any of the above or other computer architectures and systems. In other embodiments, the functions of the system can be implemented partially or completely in firmware, programmable logic devices such as field programmable gate arrays (FPGAs) as referenced in FIG. 22, system on chips (SOCs), application specific integrated circuits (ASICs), or other processing and logic elements. For example, the Set Processor and Optimizer can be implemented with hardware acceleration through the use of a hardware accelerator card, such as accelerator card 2012 illustrated in FIG. 20.

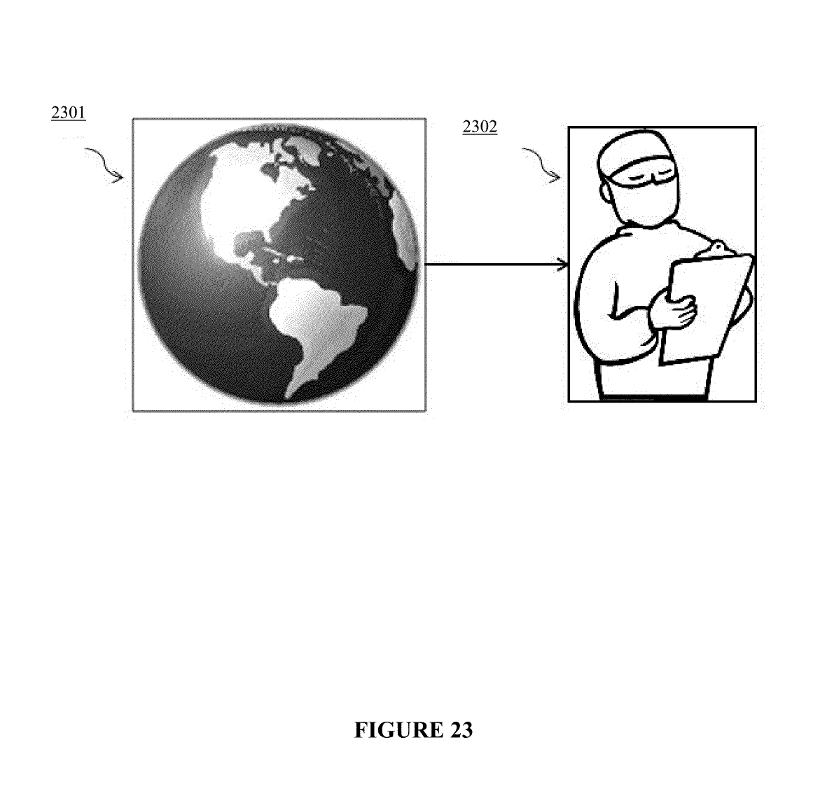

Any embodiment of the invention described herein can be, for example, produced and transmitted by a user within the same geographical location. A product of the invention can be, for example, produced and/or transmitted from a geographic location in one country and a user of the invention can be present in a different country. In some embodiments, the data accessed by a system of the invention is a computer program product that can be transmitted from one of a plurality of geographic locations 2301 to a user 2302 (FIG. 23). Data generated by a computer program product of the invention can be transmitted back and forth among a plurality of geographic locations, for example, by a network, a secure network, an insecure network, an internet, or an intranet. In some embodiments, a system herein is encoded on a physical and tangible product.

### EMBODIMENTS

### Embodiment 1

A method of managing a health condition of a subject, the method comprising: a) collecting data related to the health condition of the subject, wherein the data comprise a result of a breathing test of the subject; b) comparing the data obtained from the subject with normal data for the health condition, wherein the normal data represents a status of the subject's health condition when in a state of good health; c) determining by a processor of a computer system a level of severity of the health condition based on the comparing; and d) providing an action plan for the subject based on the level of severity of the health condition, wherein the action plan comprises individualized instructions to manage the health condition.

### Embodiment 2

The method of Embodiment 1, wherein the health condition is asthma.

### Embodiment 3

The method of any one of Embodiments 1-2, wherein the health condition is a chronic health condition.

### Embodiment 4

The method of any one of Embodiments 1-3, wherein the health condition is chronic obstructive pulmonary disease.

### Embodiment 5

The method of any one of Embodiments 1-4, wherein the data comprise a peak expiratory flow reading of the subject.

### Embodiment 6

The method of any one of Embodiments 1-5, wherein the data comprise a spirometry reading of the subject.

### Embodiment 7

The method of any one of Embodiments 1-6, wherein the level of severity is one of no more than four different levels.

### Embodiment 8

The method of any one of Embodiments 1-7, wherein the level of severity is one of three different levels.

### Embodiment 9

The method of any one of Embodiments 1-8, wherein the data are obtained from a measurement of the subject taken by a medical device.

### Embodiment 10

The method of Embodiment 9, wherein the medical device is a peak flow meter.

### Embodiment 11

The method of Embodiment 9, wherein the medical device is a spirometry device.

### Embodiment 12

The method of any one of Embodiments 1-11, wherein the data characterize a physical condition of the user.

### Embodiment 13

The method of any one of Embodiments 1-12, wherein the data characterize a symptom of the health condition.

### Embodiment 14

The method of any one of Embodiments 1-13, wherein the data comprise a medication administered to the subject.

### Embodiment 15

The method of any one of Embodiments 1-14, wherein the data are collected from a healthcare provider.

### Embodiment 16

The method of any one of Embodiments 1-15, wherein the data are collected from the subject.

### Embodiment 17

The method of any one of Embodiments 1-16, wherein at least a portion of the action plan is based on an asthma action plan.

### Embodiment 18

The method of any one of Embodiments 1-17, wherein at least a portion of the action plan is based on a chronic obstructive pulmonary disease action plan.

### Embodiment 19

The method of any one of Embodiments 1-18, wherein the individualized instructions comprise directions to administer a medication.

### Embodiment 20

The method of any one of Embodiments 1-19, further comprising: collecting health insurance information about the subject.

### Embodiment 21

The method of any one of Embodiments 1-20, further comprising: ordering a medication for the subject.

### Embodiment 22

The method of any one of Embodiments 1-21, further comprising: entering into a database the collected data related to the health condition of the subject.

### Embodiment 23

The method of Embodiment 22, further comprising: analyzing the database thereby determining a statistical correlation of the collected data with the health condition.

### Embodiment 24

The method of any one of Embodiments 1-23, further comprising: comparing the collected data related to the health condition of the subject with a database of health data obtained from a plurality of subjects, and assessing the subject's health condition based on the comparison.

What is claimed is:

1. A method of managing a health condition of a subject, the method comprising:
a) collecting data related to the health condition of the subject, wherein the data comprise a result of a breathing test of the subject;
b) comparing the data obtained from the subject with normal data for the health condition, wherein the normal data represents a status of the subject's health condition when in a state of good health;
c) determining by a processor of a computer system a level of severity of the health condition based on the comparing; and
d) providing an action plan for the subject based on the level of severity of the health condition, wherein the action plan comprises individualized instructions to manage the health condition.

2. The method of claim 1, wherein the health condition is asthma.

3. The method of claim 1, wherein the health condition is a chronic health condition.

4. The method of claim 1, wherein the health condition is chronic obstructive pulmonary disease.

5. The method of claim 1, wherein the data comprise a peak expiratory flow reading of the subject.

6. The method of claim 1, wherein the data comprise a spirometry reading of the subject.

7. The method of claim 1, wherein the level of severity is one of no more than four different levels.

8. The method of claim 1, wherein the level of severity is one of three different levels.

9. The method of claim 1, wherein the data are obtained from a measurement of the subject taken by a medical device.

10. The method of claim 9, wherein the medical device is a peak flow meter.

11. The method of claim 9, wherein the medical device is a spirometry device.

12. The method of claim 1, wherein the data characterize a physical condition of the user.

13. The method of claim 1, wherein the data characterize a symptom of the health condition.

14. The method of claim 1, wherein the data comprise a medication administered to the subject.

15. The method of claim 1, wherein the data are collected from a healthcare provider.

16. The method of claim 1, wherein the data are collected from the subject.

17. The method of claim 1, wherein at least a portion of the action plan is based on an asthma action plan.

18. The method of claim 1, wherein at least a portion of the action plan is based on a chronic obstructive pulmonary disease action plan.

19. The method of claim 1, wherein the individualized instructions comprise directions to administer a medication.

20. The method of claim 1, further comprising: collecting health insurance information about the subject.

21. The method of claim 1, further comprising: ordering a medication for the subject.

22. The method of claim 1, further comprising: entering into a database the collected data related to the health condition of the subject.

23. The method of claim 22, further comprising: analyzing the database thereby determining a statistical correlation of the collected data with the health condition.

24. The method of claim 1, further comprising: comparing the collected data related to the health condition of the subject with a database of health data obtained from a plurality of subjects, and assessing the subject's health condition based on the comparison.
